(19) United States
(12) Patent Application Publication
(10) Pub. No.: US 2004/0151312 A1
(43) Pub. Date: Aug. 5, 2004

(54) Device key decryption apparatus, device key encryption apparatus, device key encryption/decryption apparatus, device key decryption method, device key encryption method, device key encryption/decryption method, and programs thereof

(76) Inventor: Ryogo Yanagisawa, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/742,945

(22) Filed: Dec. 23, 2003

(30) Foreign Application Priority Data
Dec. 26, 2002 (JP) 2002-375703

(51) Int. Cl. H04L 9/00

(52) U.S. Cl. 380/45

(57) ABSTRACT

There are provided, on a single LSI (114), a device inherent value (17) that is a predetermined constant value; a key generation means (18) for generating a key for encrypting a device key (11) that is the basis for generating a contents key, by using the device inherent value (17) and device inherent information (16) given to a device; and a device key encryption means (12) for encrypting the device key (11) using a key generated by the key generation means (18) to output an encrypted device key.

### FIELD OF THE TNVENTTON

The present invention relates to a device key decryption apparatus, a device key encryption apparatus, a device key encryption/decryption apparatus, a device key decryption method, a device key encryption method, a device key encryption/decryption method, and program recording media thereof, which are used for performing data transmission/reception with safety while concealing data from third party, in such as DTCP (Digital Transmission Content Protection) that is an encryption method employed for a STB (Set Top Box), a DVD recorder, and an IEEE1394 serial interface, or HDCP (High-Bandwidth Digital Content Protection) that is an encryption method employed for a DVI (Digital Visual Interface).

### BACKGROUND OF THE INVENTION

Conventionally, a copyrighted work such as a video signal or an audio signal (hereinafter referred to as “contents”) has been encrypted with a contents key so as to prevent illegal acts such as illegal copying. If this contents key is discovered by a third party with an evil intention, the above-mentioned encryption becomes meaningless. Therefore, for example, a contents key is generated according to a predetermined procedure when recording contents so that the contents key is not stationarily present in a device. As a method for generating a contents key, there has been known a method of generating a contents key on the basis of a device key, or a device key and a plurality of information other than the device key (refer to Japanese Published Patent Application No. 2000-73396 (Page 6, FIG. 2).

Generally, as for a device key to be the basis of a contents key, each device (e.g., DVD recorder) employs its own device key. This is because, when an illegal act performed on the contents, such as illegal copying of the contents, is discovered, only the device that has performed the illegal act can be removed by disabling the device key used for the illegal act.

As described above, since the device key is the basis of the contents key that is required when encrypting or decrypting the contents, the device key as well as the contents key must be concealed from the third party to prevent illegal use of the contents. In order to insist high security of the system, the device key must be particularly concealed from the third party with higher reliability when the procedure of generating the contents key is disclosed.

Hereinafter, a conventional device key decryption apparatus and a conventional device key encryption apparatus will be described with reference to FIG. 13. FIG. 13 is a block diagram illustrating the construction of a conventional contents encryption/decryption apparatus including a device key encryption unit and a device key decryption unit.

A conventional contents encryption/decryption apparatus 1310 comprises an encrypted device key recording means 1316 for receiving a device key 1311 that has been encrypted by a device key encryption means 1302 in a device key encryption apparatus 1303 (hereinafter referred to as “an encrypted device key”), and recording the encrypted device key; a device key decryption unit 1313 for decrypting the encrypted device key 1311; a contents key generation means 1314 for generating a contents key on the basis of the decrypted device key 11; and a contents encryption/decryption means 1315 for encrypting or decrypting the contents using the generated contents key. The device key decryption unit 1313 contains an encryption/decryption key 1301 for decrypting the encrypted device key 1311, and a device key decryption means 1312 for decrypting the encrypted device key 1311 using the encryption/decryption key 1301.

Hereinafter, the operation will be described. In the conventional device key encryption apparatus 1303, initially, the device key encryption means 1302 performs encryption of the device key 11 using the encryption/decryption key 1301 that is a key for encrypting the device key 11. As for the conventional device key encryption apparatus 1303, those constituted by software on microcomputers or personal computers have widely been used.

The encrypted device key 1311 that is obtained in the device key encryption apparatus 1303 is usually recorded in the encrypted device key recording means 1316 in the contents encryption/decryption apparatus 1310. The encrypted device key recording means 1316 is a rewritable memory capable of long-term storage, such as an EEPROM.

The device key encryption apparatus 1303 is connected only when the encrypted device key 1311 should be recorded in the encrypted device key recording means 1316 in the contents encryption/decryption apparatus 1310 (for example, when the contents encryption/decryption apparatus 1310 is manufactured), and it is not connected when the contents encryption/decryption apparatus 1310 is normally used.

In the contents encryption/decryption apparatus 1310, the encrypted device key 1311 obtained by the device key encryption apparatus 1303 is decrypted using the encryption/decryption key 1301 in the device key decryption means 1312 in the device key decryption unit 1313 to obtain the device key 11, and a contents key is generated using the device key 11 in the contents key generation means 1314. Further, in the contents encryption/decryption means 1315, the encrypted contents is decrypted (e.g., the encrypted contents obtained from a DVD or the like is decrypted to be displayed on a display unit) or the contents is encrypted (e.g., the contents is encrypted to be recorded on a DVD or the like) using the generated contents key.

In the above description, as shown in FIG. 13, the key for encrypting the device key 11 by the device key encryption apparatus 1303 and the key for decrypting the encrypted device key 1311 by the device key decryption apparatus 1313 are the same key as shown in FIG. 13. However, when a public-key encryption system is employed, the key for encrypting the device key 11 by the device key encryption apparatus 1303 and the key for decrypting the encrypted device key 1311 by the device key decryption apparatus 1313 may be different from each other.

As described above, the conventional contents encryption/decryption apparatus 1310 is connected to the device key encryption apparatus 1303 for encrypting the device key, only when the contents encryption/decryption apparatus 1310 is manufactured, while the device key 11 is maintained in its encrypted state when the apparatus 1310 is normally used, whereby the device key 11 is concealed from the third party.

However, as is evident from FIG. 13, in the conventional contents encryption/decryption apparatus 1310, device key decryption apparatus 1313, or device key encryption apparatus 1303, the encryption/decryption key 1301 for encrypting or decrypting the device key 11 is contained in the device without being encrypted. Further, since the encryption/decryption key 1301 is not a key that varies from device to device like the device key, if the third party should discover the encryption/decryption key 1301, the third party can discover the device keys of all devices as well, and thereby the mechanism of excluding only the device that has performed an illegal act does not work at all.

Furthermore, as for the conventional device key encryption apparatus 1303, those constituted by software on microcomputers and personal computers have been widely used. Therefore, if the software or the like should be illegally decrypted by the third party, the third party might discover the encryption/decryption key 1301 and the encryption method.

### SUMMARY OF THE INVENTION

The present invention is made to solve the above-described problems and has for its object to provide a device key decryption apparatus, a device key encryption apparatus, a device key encryption/decryption apparatus, a device key decryption method, a device key encryption method, a device key encryption/decryption method, and programs thereof, which can conceal the device key from the third party, and make it very difficult for the third party to illegally obtain the device key.

Other objects and advantages of the invention will become apparent from the detailed description that follows. The detailed description and specific embodiments described are provided only for illustration since various additions and modifications within the scope of the invention will be apparent to those of skill in the art from the detailed description.

According to the 1st aspect of the present invention, there is provided a device key decryption apparatus for decrypting an encrypted device key which is obtained by encrypting a device key that is the basis of a contents key for encrypting or decrypting contents and varies from device to device, and the apparatus includes: a key generation means for generating a key, using device inherent information that is given to a device, and a device inherent value that is a predetermined constant value; and a device key decryption means for decrypting the encrypted device key using the key generated by the key generation means, thereby to output the device key. Therefore, it is possible to provide a device key decryption apparatus having a high level of security, which can make the key for decrypting the encrypted device key vary from device to device, and make it impossible for the third party to estimate the device key from the encrypted device key.

According to the 2nd aspect of the present invention, in the device key decryption apparatus according to the 1st aspect, the device inherent information and the encrypted device key are stored in the same memory. Therefore, the memories in the device can be commonized, whereby the whole device can be constituted at low cost.

According to the 3rd aspect of the present invention, in the device key decryption apparatus according to the 1st aspect, the device inherent value, the key generation means, and the device key decryption means are integrated on the same LSI. Therefore, it becomes difficult for the third party to decrypt the device inherent value, the key generation means, and the device key decryption means, thereby providing a device key decryption apparatus which can conceal, from the third party, what key and what algorithm have been used for decrypting the encrypted device key, and can make it impossible to practically decrypt the device key by an illegal attack from the outside.

According to the 4th aspect of the present invention, there is provided a device key decryption apparatus for decrypting an encrypted device key which is obtained by encrypting a device key that is the basis of a contents key for encrypting or decrypting contents and varies from device to device, and the apparatus includes: an encrypted device information holding means for holding device inherent information that is given to a device, and the encrypted device key; a key generation means for generating a key using a device inherent value that is a predetermined constant value, and the device inherent information; a device key decryption means for decrypting the encrypted device key using the key generated by the key generation means, thereby to output the device key; and a control means for controlling the encrypted device information holding means, the key generation means, and the device key decryption means. Therefore, the key for decrypting the encrypted device key can be varied from device to device, whereby it becomes impossible for the third party to estimate the device key from the encrypted device key, and moreover, the construction of the device key decryption apparatus can be simplified.

According to the 5th aspect of the present invention, in the device key decryption apparatus according to the 4th aspect, the device inherent value, the key generation means, and the device key decryption means are integrated on the same LSI. Therefore, it becomes difficult for the third party to decrypt the device inherent value, the key generation means, and the device key decryption means, thereby providing a device key decryption apparatus which can conceal, from the third party, what key and what algorithm have been used for decrypting the encrypted device key, and can make it impossible to practically decrypt the device key by an illegal attack from the outside.

According to the 6th aspect of the present invention, in the device key decryption apparatus according to the 4th aspect, the device inherent information is encrypted and held; and the key generation means generates a key using the device inherent value, and either the encrypted device inherent information or the decrypted device inherent information that is obtained after decrypting the encrypted device inherent information. Therefore, the device inherent information can also be concealed from the third party, resulting in a device key decryption apparatus having a higher level of security.

According to the 7th aspect of the present invention, in the device key decryption apparatus according to the 4th aspect, the encrypted device information holding means holds information possessed by another device key decryption apparatus that is different from the device key decryption apparatus, in addition to the device inherent information and the encrypted device key. Therefore, the memories can be commonized among plural apparatuses, whereby the whole device can be constituted at lower cost.

According to the 8th aspect of the present invention, in the device key decryption apparatus according to the 1st or 4th aspect, the device inherent information comprises at least one of classification data that identify the device. Therefore, the device inherent information can be information specific to the corresponding device, and the key for decrypting the encrypted device key, which is generated by the key generation means, can be information that varies from device to device, thereby making it difficult for the third party to estimate the device key from the encrypted device key.

According to the 9th aspect of the present invention, in the device key decryption apparatus according to the 8th aspect, the classification data include a code of a maker that manufactures the device, a code of a factory where the device is manufactured, a product field code of the device, a product model code of the device, and a serial number of the device. Therefore, the device inherent information can be information specific to each device.

According to the 10th aspect of the present invention, in the device key decryption apparatus according to the 1st or 4th aspect, the device inherent information varies from device to device. Therefore, the key for decrypting the encrypted device key, which is generated by the key generation means, can be varied from device to device, thereby making it more difficult for the third party to estimate the device key from the encrypted device key.

According to the 11th aspect of the present invention, in the device key decryption apparatus according to the 1st or 4th aspect, the key generation means is an exclusive OR circuit which calculates an exclusive OR of the device inherent information and the device inherent value, thereby to generate a key. Therefore, it is possible to generate a key for decrypting the encrypted device key, which varies from device to device, thereby making it difficult for the third party to estimate the device key from the encrypted device key.

According to the 12th aspect of the present invention, in the device key decryption apparatus according to the 1st or 4th aspect, the key generation means is an encryption circuit which encrypts the device inherent information using the device inherent value as a key, thereby to generate a key. Therefore, it is possible to generate a key for decrypting the encrypted device key, which varies from device to device, thereby making it more difficult for the third party to estimate the device key from the encrypted device key.

According to the 13th aspect of the present invention, in the device key decryption apparatus according to the 1st or 4th aspect, the key generation means is a compression means for compressing a number sequence using a one-way function, and generates a key by compressing a number sequence that is obtained by concatenating the device inherent information with the device inherent value, using the one-way function. Therefore, it is possible to generate a key for decrypting the encrypted device key, which varies from device to device, thereby making it almost impossible for the third party to estimate the device key from the encrypted device key.

According to the 14th aspect of the present invention, there is provided a device key encryption apparatus for encrypting a device key which is the basis of a contents key for encrypting or decrypting contents, and varies from device to device, and the apparatus includes: a key generation means for generating a key using device inherent information that is given to a device, and a device inherent value that is a predetermined constant value; and a device key encryption means for encrypting the device key using the key generated by the key generation means, thereby to output the encrypted device key. Therefore, it is possible to provide a device key encryption apparatus having a high level of security, which can make the key for encrypting the device key vary from device to device, and can make it impossible for the third party to estimate the device key.

According to the 15th aspect of the present invention, in the device key encryption apparatus according to the 14th aspect, the device inherent information and the device key are stored in the same memory. Therefore, the memories in the device can be commonized, whereby the whole device can be constituted at low cost.

According to the 16th aspect of the present invention, in the device key encryption apparatus according to the 14th aspect, the device inherent value, the key generation means, and the device key encryption means are integrated on the same LSI. Therefore, it becomes difficult for the third party to decrypt the device inherent value, the key generation means, and the device key encryption means, thereby providing a device key encryption apparatus which can conceal, from the third party, what key and what algorithm have been used for encrypting the device key, and can make it impossible to practically decrypt the device key by an illegal attack from the outside.

According to the 17th aspect of the present invention, there is provided a device key encryption apparatus for encrypting a device key that is the basis of a contents key for encrypting or decrypting contents, and varies from device to device, and the apparatus includes: a device key holding means for holding the device key; a device key encryption means for encrypting the device key using an encryption key, thereby to output an encrypted device key; an encrypted device key recording means for recording the encrypted device key; and a control means for controlling the device key holding means, the device key encryption means, and the encrypted device key recording means; wherein the encryption key and the device key encryption means are integrated on the same LSI. Therefore, it becomes difficult for the third party to decrypt the encryption key for encrypting the device key, and the device key encryption means, thereby providing a device key encryption apparatus which can conceal, from the third party, what key and what algorithm have been used for encrypting the device key, and can make it impossible to practically decrypt the device key by an illegal attack from the outside.

According to the 18th aspect of the present invention, in the device key encryption apparatus according to the 17th aspect, the device key holding means and the encrypted device key recording means are constituted by the same memory. Therefore, the memories in the device can be commonized, whereby the whole device can be constituted at low cost.

According to the 19th aspect of the present invention, in the device key encryption apparatus according to the 17th aspect, the encrypted device key recording means records, in addition to the encrypted device key, information possessed by another device key encryption apparatus that is different from the device key encryption apparatus. Therefore, the memories can be commonized among plural apparatuses, whereby the whole device can be constituted at lower cost.

According to the 20th aspect of the present invention, there is provided a device key encryption apparatus for encrypting a device key which is the basis of a contents key for encrypting or decrypting contents, and varies from device to device, and the apparatus includes: a device information holding means for holding device inherent information given to a device, and the device key; a key generation means for generating a key using a device inherent value that is a predetermined constant value, and the device inherent information; a device key encryption means for encrypting the device key using the key generated by the key generation means, thereby to output an encrypted device key; an encrypted device information recording means for recording the encrypted device key; and a control means for controlling the device information holding means, the key generation means, the device key encryption means, and the encrypted device information recording means. Therefore, the key for encrypting the device key can be varied from device to device, thereby making it impossible for the third party to estimate the device key from the encrypted device key, resulting in a device key encryption apparatus having a high level of security.

According to the 21st aspect of the present invention, in the device key encryption apparatus according to the 20th aspect, the device inherent value, the key generation means, and the device key encryption means are integrated on the same LSI. Therefore, it becomes difficult for the third party to decrypt the device inherent value, the key generation means, and the device key encryption means, resulting in a device key encryption apparatus which can conceal, from the third party, what key and what algorithm have been used for encrypting the device key, and can make it impossible to practically decrypt the device key by an illegal attack from the outside.

According to the 22nd aspect of the present invention, in the device key encryption apparatus according to the 20th aspect, the device information holding means and the encrypted device information recording means are constituted by the same memory. Therefore, the memories in the device can be commonized, whereby the whole device can be constituted at low cost.

According to the 23rd aspect of the present invention, in the device key encryption apparatus according to the 23rd aspect, the encrypted device information recording means records, in addition to the encrypted device key, information possessed by another device key encryption apparatus that is different from the device key encryption apparatus. Therefore, the memories can be commonized among plural apparatuses, whereby the whole device can be constituted at lower cost.

According to the 24th aspect of the present invention, in the device key encryption apparatus according to the 20th aspect, the encrypted device information recording means records the device inherent information in addition to the encrypted device key. Therefore, the memories in the device can be further commonized, whereby the whole device can be constituted at lower cost.

According to the 25th aspect of the present invention, in the device key encryption apparatus according to the 24th aspect, the device inherent information is encrypted and recorded; and the key generation means generates a key using the device inherent value, and either the encrypted device inherent information or the decrypted device inherent information that is obtained after decrypting the encrypted device inherent information. Therefore, the device inherent information can also be concealed from the third party, resulting in a device key encryption apparatus having a higher level of security.

According to the 26th aspect of the present invention, in the device key encryption apparatus according to the 14th or 20th aspect, the device inherent information comprises at least one of classification data that identify the device. Therefore, the device inherent information can be information specific to the corresponding device, and the key for encrypting the device key, which is generated by the key generation means, can be information that varies from device to device, thereby making it difficult for the third party to estimate the device key from the encrypted device key.

According to the 27th aspect of the present invention, in the device key encryption apparatus according to the 14th or 20th aspect, the device inherent information varies from device to device. Therefore, the key for decrypting the encrypted device key, which is generated by the key generation means, can be varied from device to device, thereby making it more difficult for the third party to estimate the device key from the encrypted device key.

According to the 28th aspect of the present invention, in the device key encryption apparatus according to the 14th or 20th aspect, the key generation means is an exclusive OR circuit which calculates an exclusive OR of the device inherent information and the device inherent value, thereby to generate a key. Therefore, it is possible to generate a key for encrypting the device key, which varies from device to device, thereby making it difficult for the third party to estimate the device key from the encrypted device key.

According to the 29th aspect of the present invention, in the device key encryption apparatus according to the 14th or 20th aspect, the key generation means is an encryption circuit which encrypts the device inherent information using the device inherent value as a key, thereby to generate a key. Therefore, it is possible to generate a key for encrypting the device key, which varies from device to device, thereby making it more difficult for the third party to estimate the device key from the encrypted device key.

According to the 30th aspect of the present invention, in the device key encryption apparatus according to the 14th or 20th aspect, the key generation means is a compression means for compressing a number sequence using an one-way function, and generates a key by compressing a number sequence obtained by concatenating the device inherent information with the device inherent value, using the one-way function. Therefore, it is possible to generate a key for encrypting the device key, which varies from device to device, thereby making it almost impossible for the third party to estimate the device key from the encrypted device key.

According to the 31st aspect of the present invention, there is provided a device key encryption/decryption apparatus for encrypting a device key that is the basis of a contents key for encrypting or decrypting contents, and varies from device to device, or decrypting an encrypted device key, and the apparatus includes: a device key holding means for holding the device key; an encrypted device key recording means for recording the encrypted device key; a device key encryption/decryption means for encrypting the device key using an encryption key to output the encrypted device key, or decrypting the encrypted device key using a decryption key to output the device key; and a control means for controlling the device key holding means, the encrypted device key recording means, and the device key encryption/decryption means; wherein the encryption key, the decryption key, and the device key encryption/decryption means are integrated on the same LSI. Therefore, it becomes difficult for the third party to decrypt the encryption key for encrypting the device key, the decryption key for decrypting the encrypted device key, and the device key encryption/decryption means, resulting in a device key encryption/decryption apparatus which can conceal what key and what algorithm have been used for encrypting the device key or what key and what algorithm have been used for decrypting the encrypted device key, and can make it impossible to practically decrypt the device key by an illegal attack from the outside.

According to the 32nd aspect of the present invention, in the device key encryption/decryption apparatus according to the 31st aspect, the encrypted device key recording means records, in addition to the encrypted device key, information possessed by another device key encryption/decryption apparatus that is different from the device key encryption/decryption apparatus. Therefore, the memories can be commonized among plural apparatuses, whereby the whole device can be constituted at lower cost.

According to the 33rd aspect of the present invention, in the device key encryption/decryption apparatus according to the 31st aspect, the device key holding means and the encrypted device key recording means are constituted by the same memory. Therefore, the memories in the device can be commonized, whereby the whole device can be constituted as low cost.

According to the 34th aspect of the present invention, in the device key encryption/decryption apparatus according to the 31st aspect, the encryption key and the decryption key are the same secrete key. Therefore, the construction of the device key encryption/decryption apparatus can be simplified, whereby the whole device can be constituted at low cost.

According to the 35th aspect of the present invention, in the device key encryption/decryption apparatus according to the 31st aspect, when encrypting the device key, the control means reads the device key from the device key holding means, controls the device key encryption/decryption means to encrypt the device key using the encryption key, and records the encrypted device key in the encrypted device key recording means; and when decrypting the encrypted device key, the control means reads the encrypted device key from the encrypted device key recording means, controls the device key encryption/decryption means to decrypt the encrypted device key using the decryption key. Therefore, the device key or the encrypted device key can be encrypted or decrypted using the encryption key or the decryption key which has previously been concealed within the apparatus, under the control of the control means, whereby the construction of the device key encryption/decryption apparatus can be simplified, and the whole device can be constituted at low cost.

According to the 36th aspect of the present invention, in the device key encryption/decryption apparatus according to the 35th aspect, when decrypting the encrypted device key, the device key holding means does not hold the device key, or it is dismounted from the device key encryption/decryption apparatus. Therefore, the encrypted device key is not present in the device when decrypting the encrypted device key, resulting in a device key encryption/decryption apparatus having a higher level of security.

According to the 37th aspect of the present invention, there is provided a device key encryption/decryption apparatus for encrypting a device key that is the basis of a contents key for encrypting or decrypting contents, and varies from device to device, or decrypting an encrypted device key, and the apparatus includes: a device key holding means for holding the device key; an encrypted device key recording means for recording the encrypted device key; a key generation means for generating a key using device inherent information given to the device, and a device inherent value that is a predetermined constant value; a device key encryption/decryption means for encrypting the device key using the key generated by the key generation means to output the encrypted device key, or decrypting the encrypted device key using the key generated by the key generation means to output the device key; and a control means for controlling the device key holding means, the encrypted device key recording means, the key generation means, and the device key encryption/decryption means. Therefore, the key for encrypting the device key or the key for decrypting the encrypted device key can be varied from device to device, thereby making it impossible for the third party to estimate the device key from the encrypted device key, resulting in a device key encryption/decryption apparatus having a high level of security.

According to the 38th aspect of the present invention, in the device key encryption/decryption apparatus according to the 37th aspect, the device inherent value, the key generation means, and the device key encryption/decryption means are integrated on the same LSI. Therefore, it becomes difficult for the third party to decrypt the device inherent value, the key generation means, and the device key encryption/decryption means, resulting in a device key encryption/decryption apparatus which can conceal what key and what algorithm have been used for encrypting the device key or what key and what algorithm have been used for decrypting the encrypted device, and can make it impossible to practically decrypt the device key by an illegal attack from the outside.

According to the 39th aspect of the present invention, in the device key encryption/decryption apparatus according to the 37th aspect, the encrypted device key recording means records, in addition to the encrypted device key, information possessed by another device key encryption/decryption apparatus that is different from the device key encryption/decryption apparatus. Therefore, the memories can be commonized among plural apparatuses, whereby the whole device can be constituted at lower cost.

According to the 40th aspect of the present invention, in the device key encryption/decryption apparatus according to the 37th aspect, the device key holding means and the encrypted device key recording means are constituted by the same memory. Accordingly, the memories in the device can be commonized, whereby the whole device can be constituted at low cost.

According to the 41st aspect of the present invention, in the device key encryption/decryption apparatus according to the. 37th aspect, when encrypting the device key, the control means reads the device key from the device key holding means, controls the key generation means to generate a key for encrypting the device key, controls the device key encryption/decryption means to encrypt the device key using the key generated by the key generation means, and records the encrypted device key in the encrypted device key recording means; and when decrypting the encrypted device key, the control means reads the encrypted device key from the encrypted device key recording means, controls the key generation means to generate a key for decrypting the encrypted device key, and controls the device key encryption/decryption means to decrypt the encrypted device key using the key generated by the key generation means. Therefore, the device key or the encrypted device key can be encrypted or decrypted under the control of the control means, whereby the construction of the device key encryption/decryption apparatus can be simplified, and the whole device can be constituted at low cost.

According to the 42nd aspect of the present invention, in the device key encryption/decryption apparatus according to the 41st aspect, when decrypting the encrypted device key, the device key holding means does not hold the device key, or it is dismounted from the device key encryption/decryption apparatus. Therefore, the device key is not present in the device when decrypting the encrypted device key, thereby providing a device key encryption/decryption apparatus having a higher level of security.

According to the 43rd aspect of the present invention, there is provided a device key encryption/decryption apparatus for encrypting a device key that is the basis of a contents key for encrypting or decrypting contents, and varies from device to device, or decrypting an encrypted device key, and the apparatus includes: a device information holding means for holding device inherent information given to a device, and the device key; an encrypted device information recording means for recording the encrypted device key; a key generation means for generating a key using device inherent that is a predetermined constant value, and the device inherent information; a device key encryption/decryption means for encrypting the device key using the key generated by the key generation means to output the encrypted device key, or decrypting the encrypted device key using the key generated by the key generation means to output the device key; and a control means for controlling the device information holding means, the encrypted device information recording means, the key generation means, and the device key encryption/decryption means. Therefore, the key for encrypting the device key or the key for decrypting the encrypted device key can be varied from device to device, thereby making it impossible for the third party to estimate the device key from the encrypted device key, resulting in a device key encryption/decryption apparatus having a high level of security. Further, since the memories can be commonized, the whole device can be constituted at low cost.

According to the 44th aspect of the present invention, in the device key encryption/decryption apparatus according to the 43rd aspect, the device inherent value, the key generation means, and the device key encryption/decryption means are integrated on the same LSI. Therefore, it becomes difficult for the third party to decrypt the device inherent value, the key generation means, and the device key encryption/decryption means, thereby providing a device key encryption/decryption apparatus which can conceal what key and what algorithm have been used for encrypting the device key or what key and what algorithm have been used for decrypting the encrypted device, and can make it impossible to practically decrypt the device key by an illegal attack from the outside.

According to the 45th aspect of the present invention, in the device key encryption/decryption apparatus according to the 43rd aspect, the encrypted device information recording means records, in addition to the encrypted device key, information possessed by another device key encryption/decryption apparatus that is different from the device key encryption/decryption apparatus. Therefore, the memories can be commonized among plural apparatuses, whereby the whole device can be constituted at lower cost.

According to the 46th aspect of the present invention, in the device key encryption/decryption apparatus according to the 43rd aspect, the device information holding means and the encrypted device information recording means are constituted by the same memory. Therefore, the memories in the device can be commonized, whereby the whole device can be constituted at low cost.

According to the 47th aspect of the present invention, in the device key encryption/decryption apparatus according to the 43rd aspect, the encrypted device information recording means records the device inherent information in addition to the encrypted device key. Therefore, the memories in the device can be further commonized, whereby the whole device can be constituted at lower cost.

According to the 48th aspect of the present invention, in the device key encryption/decryption apparatus according to the 47th aspect, the device inherent information is encrypted and recorded; and the key generation means generates a key using the device inherent value, and either the encrypted device inherent information or the decrypted device inherent information that is obtained after decrypting the encrypted device inherent information. Therefore, the device inherent information can also be concealed from the third party, thereby providing a device key encryption/decryption apparatus having a higher level of security.

According to the 49th aspect of the present invention, in the device key encryption/decryption apparatus according to the 43rd aspect, when encrypting the device key, the control means reads the device key and the device inherent information from the device information holding means, controls the key generation means to generate a key for encrypting the device key, controls the device key encryption/decryption means to encrypt the device key using the key generated by the key generation means, and records the encrypted device key in the encrypted device information recording means; and when decrypting the encrypted device key, the control means reads the encrypted device key from the encrypted device information recording means, controls the key generation means to generate a key for decrypting the encrypted device key, and controls the device key encryption/decryption means to decrypt the encrypted device key using the key generated by the key generation means. Therefore, the device key or the encrypted device key can be encrypted or decrypted under the control of the control device, whereby the construction of the device key encryption/decryption apparatus can be simplified, and the whole device can be constituted at low cost.

According to the 50th aspect of the present invention, in the device key encryption/decryption apparatus according to the 49th aspect, when decrypting the encrypted device key, the device information holding means does not hold the device key, or it is dismounted from the device key encryption/decryption apparatus. Therefore, the device key is not present in the device when decrypting the encrypted device key, thereby providing a device key encryption/decryption apparatus having a higher level of security.

According to the 51st aspect of the present invention, in the device key encryption/decryption apparatus according to the 37th or 43rd aspect, the device inherent information comprises at least one of classification data that identify the device. Therefore, the device inherent information can be information specific to the corresponding device, and the key for decrypting the encrypted device key or the key for encrypting the device key, which is generated in the key generation means, can be information that varies from device to device, thereby making it difficult for the third party to estimate the device key from the encrypted device key.

According to the 52nd aspect of the present invention, in the device key encryption/decryption apparatus according to the 37th or 43rd aspect, the device inherent information varies from device to device. Therefore, the key for decrypting the encrypted device key or the key for encrypting the device key, which is generated by the key generation means, can be varied from device to device, thereby making it more difficult for the third party to estimate the device key from the encrypted device key.

According to the 53rd aspect of the present invention, in the device key encryption/decryption apparatus according to the 37th or 43rd aspect, the key generation means is an exclusive OR circuit, and generates a key by calculating an exclusive OR between the device inherent information and the device inherent value. Therefore, it is possible to generate a key for decrypting the encrypted device key or a key for encrypting the device key, which varies from device to device, thereby making it difficult for the third party to estimate the device key from the encrypted device key.

According to the 54th aspect of the present invention, in the device key encryption/decryption apparatus according to the 37th or 43rd aspect, the key generation means is an encryption circuit, and encrypts the device inherent information using the device inherent value as a key to generate a key. Therefore, it is possible to generate a key for decrypting the encrypted device key or a key for encrypting the device key, which varies from device to device, thereby making it more difficult for the third party to estimate the device key from the encrypted device key.

According to the 55th aspect of the present invention, in the device key encryption/decryption apparatus according to the 37th or 43rd aspect, the key generation means is a compression means for compressing a number sequence using a one-way function, and generates a key by compressing a number sequence that is obtained by concatenating the device inherent information with the device inherent value, using the one-way function. Therefore, it is possible to generate a key for decrypting the encrypted device key or a key for encrypting the device key, which varies from device to device, thereby making it almost impossible for the third party to estimate the device key from the encrypted device key.

According to the 56th aspect of the present invention, there is provided a device key decryption method for decrypting an encrypted device key which is obtained by encrypting a device key that is the basis of a contents key for encrypting or decrypting contents, and varies from device to device, and the method includes generating a key for decrypting the encrypted device key using device inherent information given to the device, and a device inherent value that is a predetermined constant value, and decrypting the encrypted device key using the generated key. Therefore, the key for decrypting the encrypted device key can be varied from device to device, thereby making it almost impossible for the third party to estimate the device key from the encrypted device key.

According to the 57th aspect of the present invention, in the device key decrypting method according to the 56th aspect, the device inherent information varies from device to device. Therefore, the key for decrypting the encrypted device key, which is generated by the key generation means, can be varied from device to device, thereby making it more difficult for the third party to estimate the device key from the encrypted device key.

According to the 58th aspect of the present invention, there is provided a device key encryption method for encrypting a device key which is the basis of a contents key for encrypting or decrypting contents, and varies from device to device, and the method includes generating a key for encrypting the device key using device inherent information given to the device, and a device inherent value that is a predetermined constant value, and encrypting the device key using the generated key. Therefore, the key for encrypting the device key can be varied from device to device, thereby making it almost impossible for the third party to estimate the device key from the encrypted device key.

According to the 59th aspect of the present invention, in the device key encrypting method according to the 58th aspect, the device inherent information varies from device to device. Therefore, the key for encrypting the device key, which is generated in the key generation means, can be varied from device to device, thereby making it more difficult for the third party to estimate the device key from the encrypted device key.

According to the 60th aspect of the present invention, there is provided a device key encryption/decryption method for encrypting a device key that is the basis of a contents key for encrypting or decrypting contents, and varies from device to device, or decrypting the encrypted device key, and the method includes, when encrypting the device key, generating a key for encrypting the device key using device inherent information that is given to the device, and a device inherent value that is a predetermined constant value, and encrypting the device key using the generated key to obtain an encrypted device key; and when decrypting the encrypted device key, generating a key for decrypting the encrypted device key, and decrypting the encrypted device key using the generated key. Therefore, the key for encrypting the device key or the key for decrypting the encrypted device key can be varied from device to device, thereby making it almost impossible for the third party to estimate the device key from the encrypted device key.

According to the 61st aspect of the present invention, in the device key encryption/decryption method according to the 60th aspect, the device inherent information varies from device to device. Therefore, the key for encrypting the device key or the key for decrypting the encrypted device key, which is generated by the key generation means, can be varied from device to device, thereby making it more difficult for the third party to estimate the device key from the encrypted device key.

According to the 62nd aspect of the present invention, there is provided a program for implementing, by a computer, a device key decryption method for decrypting an encrypted device key which is obtained by encrypting a device key that is the basis of a contents key for encrypting or decrypting contents, and varies from device to device, and the program includes generating a key for decrypting the encrypted device key using device inherent information given to the device, and a device inherent value that is a predetermined constant value, and decrypting the encrypted device key using the generated key. Therefore, the key for decrypting the encrypted device key can be varied from device to device, and decryption of the encrypted device key can be realized by the computer using the key that varies from device to device, thereby concealing the device key from the third party, and making it very difficult for the third party to illegally obtain the device key.

According to the 63rd aspect of the present invention, there is provided a program for implementing, by a computer, a device key encryption method for encrypting a device key which is the basis of a contents key for encrypting or decrypting contents, and varies from device to device, and the program includes generating a key for encrypting the device key using device inherent information given to the device, and a device inherent value that is a predetermined constant value, and encrypting the device key using the generated key. Therefore, the key for encrypting the device key can be varied from device to device, and encryption of the device key can be realized by the computer using the key that varies from device to device, thereby concealing the device key from the third party, and making it very difficult for the third party to illegally obtain the device key.

According to the 64th aspect of the present invention, there is provided a program for implementing, by a computer, a device key encryption/decryption method for encrypting a device key that is the basis of a contents key for encrypting or decrypting contents, and varies from device to device, or decrypting the encrypted device key, and the program includes, when encrypting the device key, generating a key for encrypting the device key using device inherent information that is given to the device, and a device inherent value that is a predetermined constant value, and encrypting the device key using the generated key to obtain an encrypted device key; and when decrypting the encrypted device key, generating a key for decrypting the encrypted device key, and decrypting the encrypted device key using the generated key. Therefore, the key for encrypting the device key or the key for decrypting the encrypted device key can be varied from device to device, and encryption of the device key or decryption of the encrypted device key can be realized by the computer using the key that varies from device to device, thereby concealing the device key from the third party, and making it very difficult for the third party to illegally obtain the device key.

### BRIEF DESCRIPTION OF THE DRAWINGS

FIG. 1 is a block diagram illustrating a device key encryption apparatus according to a first embodiment of the present invention.

FIG. 2 is a diagram illustrating device inherent information according to the first embodiment.

FIG. 3 is a block diagram illustrating a key generation means according to the first embodiment.

FIG. 4 is a diagram illustrating information generated by a concatenation means in the key generation means according to the first embodiment.

FIG. 5 is a block diagram illustrating a device key encryption apparatus according to a second embodiment of the present invention.

FIG. 6 is a block diagram illustrating a device key encryption apparatus according to a third embodiment of the present invention.

FIG. 7 is a block diagram illustrating a contents encryption/decryption apparatus including a device key decryption apparatus according to a fourth embodiment of the present invention.

FIG. 8 is a block diagram illustrating a contents encryption/decryption apparatus including a device key decryption apparatus having another construction according to the fourth embodiment.

FIG. 9 is a block diagram illustrating a contents encryption/decryption apparatus including a device key encryption/decryption apparatus according to a fifth embodiment of the present invention.

FIG. 10 is a block diagram illustrating a contents encryption/decryption apparatus including a device key encryption/decryption apparatus according to a sixth embodiment.

FIG. 11 is a block diagram illustrating a contents encryption/decryption apparatus including a device key encryption/decryption apparatus having another construction according to the sixth embodiment.

FIG. 12 is a block diagram illustrating a contents encryption/decryption apparatus including a device key encryption/decryption apparatus according to a seventh embodiment of the present invention.

FIG. 13 is a diagram illustrating a contents encryption/decryption apparatus including a device key encryption apparatus and a device key decryption apparatus according to the prior art.

### DETAILED DESCRIPTION OF PRFFERRED EMBODIMENTS

Hereinafter, preferred embodiments of the present invention will be described with reference to the drawings.

[Embodiment 1]

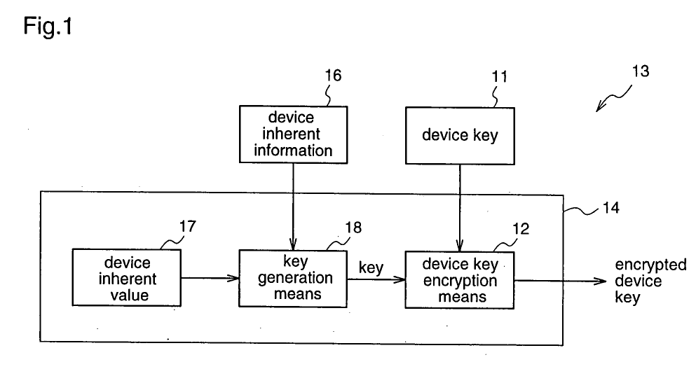

A device key encryption apparatus according to a first embodiment of the present invention will be described with reference to FIGS. 1˜4. The device key encryption apparatus according to the first embodiment generates a key for encrypting a device key using information inherent to each device, and encrypts the device key using the generated key.

FIG. 1 is a block diagram illustrating a device key encryption apparatus according to the first embodiment. In FIG. 1, reference numeral 13 denotes a device key encryption apparatus for encrypting a device key 11, numeral 16 denotes device inherent information that is given to each device, numeral 17 denotes a device inherent value that is a predetermined constant value, numeral 11 denotes a device key as the basis of a contents key, which varies from device to device, numeral 18 denotes a key generation means for generating a key for encrypting the device key, and numeral 12 denotes a device key encryption means for encrypting the device key 11 using the key generated by the key generation means 18. Further, reference numeral 14 denotes an integrated circuit (hereinafter referred to as an “LSI”). In this first embodiment, the device inherent value 17, the key generation means 18, and the device key encryption means 12 are integrated on the LSI 14.

Next, the operation of the device key encryption apparatus 13 constructed as described above will be described.

In the device key encryption apparatus 13, as described above, a key for encrypting the device key 11 is generated by the key generation means 18 using the device inherent information 16 and the device inherent value 17.

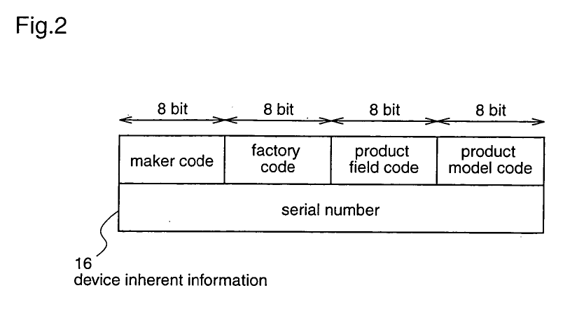

Initially, the device inherent information 16 will be described. FIG. 2 shows an example of device inherent information according to the first embodiment. As shown in FIG. 2, the device inherent information 16 is data of 64 bits comprising a maker code of 8 bits, a factory code of 8 bits, a product field code of 8 bits, a product model code of 8 bits, and a serial number of 32 bits. Hereinafter, the respective codes will be described in detail.

First of all, the maker code is a numeric value of 8 bits which is assigned to each maker that manufactures devices. Accordingly, different makers of devices have different values of maker codes.

Next, the factory code is a numeric value that varies depending on factories where each maker manufactures the devices. For example, different factories have different numeric values.

The product field code is a numeric value that varies depending on the product fields of the devices. For example, an STB and a DVD recorder have different numeric values.

The product model code is a numeric value that varies depending on the models of the devices even in the same product field. For example, even in the field of DVD recorders, the product model code varies depending on the years when the devices were manufactured, the functions of the devices, or the like.

The serial number is assigned to each device.

As described above, different codes are provided for the maker of the device, the factory where the device is manufactured, the product field of the device, and the product model of the device, and these data are combined to constitute the device inherent information 16, whereby the device inherent information 16 that varies from device to device can be assigned to all devices. This enables encryption of the device key 11 using the key that varies from device to device, and thereby the security of the system can be improved as compared with the conventional system in which the device key 11 is encrypted using the fixed encryption/decryption key 1301.

While in this first embodiment the device inherent information 16 comprises the maker code, the factory code, the product field code, the product model code, and the serial number, it is not necessary for the device inherent information 16 to include all of these codes. For example, the device inherent information 16 may comprise only the maker code or the product field code. Further, while the device inherent information 16 has 64 bits, the present invention is not restricted thereto. The device inherent information 16 may have an arbitrary number of bits so long as the device can be identified by the information 16, preferably, plural devices can be distinguished from each other.

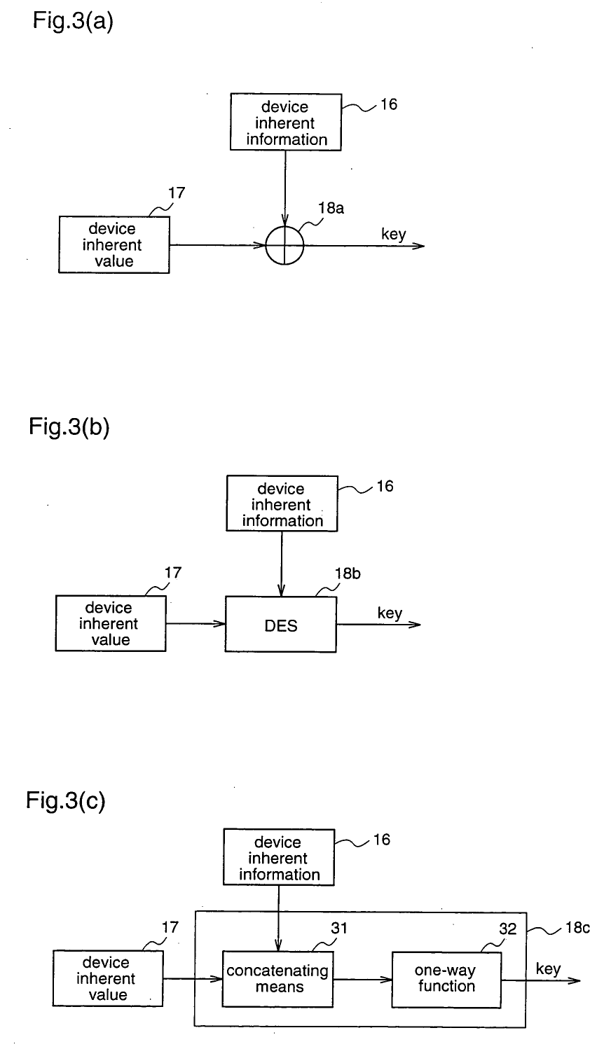

Next, the construction of the key generation means 18 will be described with reference to FIGS. 3(a), 3(b), and 3(c) which illustrate examples of constructions of the key generation means of the device key encryption apparatus according to the first embodiment, respectively.

Initially, a key generation means 18a as a first example will be described with reference to FIG. 3(a). The key generation means 18a is constituted by an exclusive OR circuit. A device inherent value 17 to be input to the key generation means 18a is a constant value that is concealed from the third party, and it may comprise any number of bits. In this example, it is a constant value of 64 bits. Then, as shown in FIG. 1, the device inherent value 17 and the key generation means 18 included in the device key encryption apparatus 13 are integrated on the same LSI 14, thereby making it difficult for the third party to decrypt the device inherent value 17. Thus, the device inherent value 17 can be concealed from the third party.

In the key generation means 18a, when generating a key for encrypting the device key 11, exclusive OR is carried out using the device inherent value 17 that is concealed from the third party, and the device inherent information 16 that varies from device to device as shown in FIG. 2, and the result of the exclusive OR, i.e., an output value that varies from device to device, is obtained as a key for encrypting the device key 11.

Accordingly; when the key generation means 18 is constructed as shown in FIG. 3(a), the key for encrypting the device key 11 can be varied from device to device. As a result, it is possible to prevent the third party from easily obtaining the device key 11 from the encrypted device key.

Next, with reference to FIG. 3(b), a key generation means 18b as a second example will be described. The key generation means 18b is an encryption circuit for encrypting the device inherent information 16 using the device inherent value 17 as a key. A DES (Data Encryption Standard) or the like is taken as an example. The device inherent value 17 to be input to the key generation means 18b is a constant value that is concealed from the third party, and it may comprise any number of bits. In this first embodiment, it is a constant value of 56 bits. Then, as shown in FIG. 1, the device inherent value 17 is integrated on the LSI 14 together with the key generation means 18 included in the device key encryption apparatus 13, thereby making it difficult for the third party to decrypt the device inherent value 17, that is, the device inherent value can be concealed from the third party.

In the key generation means 18b, when generating a key for encrypting the device key 11, the device inherent value 17 concealed from the third party is encrypted using the device inherent information 16 that varies from device to device, and the result of the encryption, i.e., an output value of 64 bits that varies from device to device, is obtained as a key for encrypting the device key 11.

Accordingly, when the key generation means 18 is constructed as shown in FIG. 3(b), the non-linearity of the key for encrypting the device key 11 can be improved, thereby making it more difficult to estimate the device inherent value 17 from the key. As a result, acquisition of the key by the third party becomes more difficult than in the case of generating a key for encrypting the device key 11 by the key generation means 18a, whereby the device key 11 can be safely encrypted to be concealed from the third party. While in this first embodiment the key generation means 18b is a DES whose algorithm has been disclosed, the key generation means 18b may be an encryption circuit using a non-disclosed encryption method. In this case, the device key 11 can be encrypted with a higher level of security, and estimation of the device key 11 by the third party can be more difficult.

Next, a key generation means 18c as a third example will be described with reference to FIG. 3(c). The key generation means 18c comprises a concatenation means 31 and a one-way function means 32.

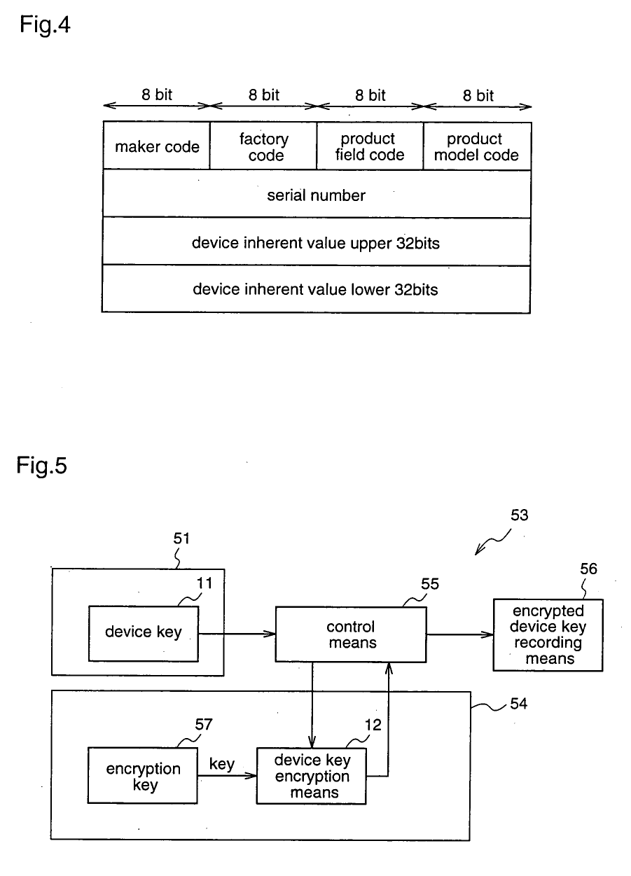

The concatenation means 31 of the key generation means 18c couples the device inherent information 16 and the device inherent value 17 to make a single sequence of numeric values. For example, when the device inherent information 16 is as shown in FIG. 16 and the device inherent value 17 is a constant value of 64 bits, the device inherent value of 64 bits is added to the end of the device inherent information 16 of 64 bits shown in FIG. 2, as shown in FIG. 4, thereby making a single sequence of numeric values. The device inherent value 17 inputted to the key generation means 18c is a constant value that is concealed from the third party as described above, and it may comprise any number of bits. Further, when the device inherent value 17 is integrated on the LSI 14 together with the key generation means 18 included in the device key encryption apparatus 13 as shown in FIG. 1, it becomes difficult for the third party to decrypt the device inherent value 17, whereby the device inherent value 17 can be concealed from the third party.

Then, the one-way function means 32 compresses, in a predetermined procedure, the numeric value sequence generated by the concatenation means 31, and the compressed value is output as a key for encrypting the device key 11. As an example of a one-way function to be used by the one-way function means 32, SHA (Secure Hash Algorithm) has widely been known. This one-way function is also called as “Hash function” wherein no inverse function exists or calculation of an inverse function is substantially impossible, and therefore, it is substantially impossible to estimate the device inherent value 17 and the device inherent information 16 from the output value that is compressed by the one-way function.

Accordingly, the construction of the key generation means as shown in FIG. 3(c) makes it practically impossible to estimate the device inherent value 17 from the key for encrypting the device key 11. As a result, acquisition of the key by the third party becomes more difficult than in the case of generating the key for encrypting the device key 11 by the key generation means 18a and 18b, whereby the device key 11 can be safely encrypted to be concealed from the third party.

Thereafter, in the device key encryption apparatus 13 of this first embodiment, the device key 11 is encrypted by the device key encryption means 12 using the key that is generated by the key generation means 18, thereby generating an encrypted device key. Then, as shown in FIG. 1, in addition to the device inherent value 17 and the key generation means 18, the device key encryption means 12 is also integrated on the same LSI 114, thereby making it difficult for the third party to decrypt the device inherent value 17, the key generation means 18, and the device key encryption means 12. Thereby, it is possible to conceal, from the third party, what key and what algorithm have been used for encrypting the device key 11, and the security of the system can be improved.

As described above, according to the first embodiment of the invention, a key for encrypting the device key 11 is generated by the key generation means 18 using the device inherent value 17 that is a concealed constant value as well as the device inherent information 16 that varies from device to device, and the device key 11 is encrypted by the device key encryption means 12 using the key generated in the key generation means 18 to obtain an encrypted device key, whereby the key for encrypting the device key 11 can be varied from device to device. Therefore, it is possible to make it difficult for the third party to easily estimate the device key 11 from the encrypted device key and easily obtain the device key 11, resulting in improved security of the system.

Further, in this first embodiment, since the device inherent value 17, the key generation means 18, and the device key encryption means 12 are integrated on the same. LSI 114, it becomes difficult for the third party to decrypt the device inherent value 17, the key generation means 18, and the device key encryption means 12, resulting in the device key encryption apparatus 13 that can conceal, from the third party, what key and what algorithm have been used for encrypting the device key 11, and that cannot practically be decrypted even by an illegal attack from the outside.

While in this first embodiment the key generation means 18 is constituted by an exclusive OR circuit, or a DES, or a one-way function, it may be constituted by combining them. The key generation means 18 may be constituted in any way as long as the device inherent value 17 cannot be easily estimated from the generated key.

Further, while in the above description the output value generated by the key generation means 18 using the device inherent information 16 and the device inherent value 17 is obtained as a key for encrypting the device key 11, the numbers of bits of the information 16 and the value 17 may be determined according to the number of bits of the generated key. For example, when a key of 56 bits is required, it may be generated by the key generation means 18 using the lower 56 bits of the device inherent information 16 and the lower 56 bits of the device inherent value 17, or the lower 56 bits of the output from the key generation means 18 may be used as the key.

Further, in the above description, the device inherent information 16 is input to the key generation means 18 as it is without being encrypted, and a key for encrypting the device key 11 is generated using the inputted device inherent information 16 and the device inherent value 17. However, the device inherent information 16 may be previously encrypted, and decrypted by the key generation means 18, or the encrypted device inherent information 16 may be used as it is. In this case, the device inherent information 16 can also be concealed from the third party, whereby the security of the system is further improved.

Furthermore, when the apparatus is constituted so that the device inherent information 16 and the device key 11 are stored in a memory or the like, these data may be held in the same memory, whereby the system can be constituted at low cost.

Furthermore, the above-described device key encryption apparatus may be implemented by software with the same effects as described above.

[Embodiment 2]

Hereinafter, a device key encryption apparatus according to a second embodiment of the present invention will be described with reference to FIG. 5. In the device key encryption apparatus 13 according to the first embodiment, a key for encrypting the device key is generated by the key generation means 18, and the device key 11 is encrypted using the generated key. In the device key encryption apparatus according to this second embodiment, however, the device key 11 is encrypted using an encryption key that is previously contained in the device key encryption apparatus so that a third party cannot encrypt the same.

FIG. 5 is a block diagram illustrating the construction of a device key encryption apparatus according to the second embodiment. In FIG. 5, reference numeral 53 denotes a device key encryption apparatus for encrypting the device key 11, numeral 51 denotes a device key holding means for holding the device key 11, numeral 57 denotes an encryption key for encrypting the device key 11, numeral 12 denotes a device key encryption means for encrypting the device key 11 using the encryption key 57, numeral 56 denotes an encrypted device key recording means for recording the encrypted device key generated in the device key encryption means 12, and numeral 55 denotes a control means for controlling the device key encryption apparatus 53. Preferably, the control means 55 is a microcomputer, and the encrypted device key recording means 56 is an EEPROM. Further, reference numeral 54 denotes a single LSI. In this second embodiment, at least the encryption key 57 and the device key encryption means 12 are integrated on the LSI 54.

As described above, the device key encryption apparatus 53 is not constituted by software on a microcomputer or the like, and the encryption key 57 and the device key encryption means 12 are integrated on the same LSI 54, thereby making it difficult for the third party to decrypt the encryption key 57 and the device key encryption means 12.

Hereinafter, the operation of the device key encryption apparatus 53 having the above-mentioned construction will be described.

In the device key encryption apparatus 53 according to the second embodiment, initially, the control means 55 reads the device key 11 that is held by the device key holding means 51. Then, under the control of the control means 55, the device key encryption means 12 encrypts the device key 11 that is read by using the encryption key 57 to generate an encrypted device key. Thereafter, the encrypted device key generated by the device key encryption means 12 is recorded in the encryption device key recording means 56 by the control means 55.

As described above, according to the device key encryption apparatus 53 of the second embodiment, because the encryption key 57 and the device key encryption means 12 are integrated on the single LSI 54, even in the case where the device key 11 is encrypted using the encryption key 57 that is previously contained in the device key encryption apparatus 53, it is possible to make it difficult for the third party to decrypt the encryption key 57 and the device key encryption means 12. Thereby, it is possible to conceal, from the third party, what key and what algorithm have been used when encrypting the device key 11, resulting in improved security of the system. Further, according to the second embodiment, it is possible to provide the device key encryption apparatus 53 that can encrypt the device key 11 with safety while concealing it from the third party, and that cannot be practically decrypted even by an illegal attack from the outside.

While in this second embodiment the device key 11 is stored in the device key holding means 51 and the encrypted device key is stored in the encrypted device key storage means 56, the device key holding means 51 and the encrypted device key recording means 56 may be constituted by the same memory. In this case, however, when the generated encrypted device key is to be recorded in the encrypted device key recording means 56 where the device key 11 has already been recorded, the device key 11 recorded in the encrypted device key recording means 56 should be automatically erased by, for example, erasing the device key or writing the encrypted device key over the device key 11. Thus, the device key 11 and the encrypted device key are prevented from simultaneously existing in the same memory.

Further, while in this second embodiment the control means 55 controls the device key encryption apparatus 53, the control means 55 may control another LSI (not shown) as well as the device key encryption apparatus 53. Further, not only the encrypted device key generated in the device key encryption apparatus 53 but also information such as an encrypted device key possessed by another LSI (not shown) may be recorded in the encrypted device key recording means 56, thereby promoting sharing of the memory. When the LSI or the memory in the apparatus is shared, the device can be constituted at lower cost.

[Embodiment 3]

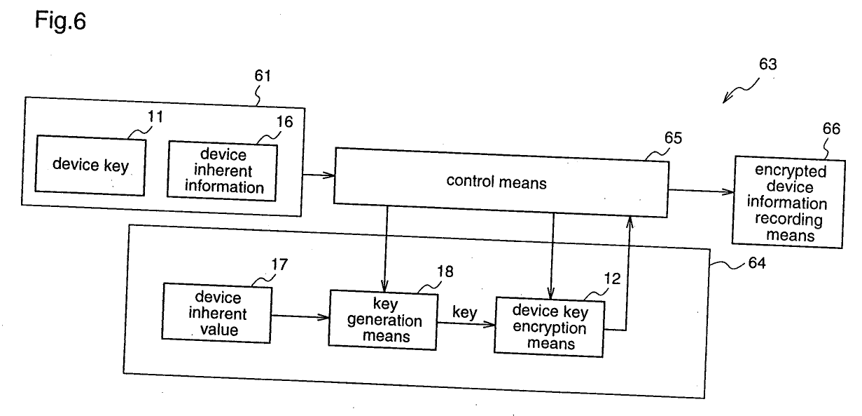

A device key encryption apparatus according to a third embodiment of the invention will be described with reference to FIG. 6. The device key encryption apparatus according to the third embodiment is provided with a control means in addition to the constitutes of the device key encryption apparatus 13 according to the first embodiment, and performs generation of a key for encrypting a device key and encryption of the device key using the generated key, under the control of the control means.

FIG. 6 is a diagram illustrating the construction of the device key encryption apparatus according to the third embodiment. In FIG. 6, reference numeral 63 denotes a device key encryption apparatus for encrypting the device key 11, numeral 61 denotes a device information holding means for holding the device key 11 and the device inherent information 16, numeral 18 denotes a key generation means for generating a key for encrypting the device key 11 using the device inherent value 17 and the device inherent information 16, numeral 12 denotes a device key encryption means for encrypting the device key 11, numeral 66 denotes an encrypted device information recording means in which at least the encrypted device key is recorded, and numeral 65 denotes a control means for controlling the device key encryption apparatus 63. Preferably, the control means 65 is a microcomputer, and the device information holding means 66 is an EEPROM. Further, reference numeral 64 denotes a single LSI. In this third embodiment, at least the device inherent value 17, the key generation means 18, and the device key encryption means 12 are integrated on the LSI 64.

Hereinafter, the operation of the device key encryption apparatus 63 constructed as described above will be described.

In the device key encryption apparatus 63, initially, the control means 65 reads the device inherent information 16 that is held in the device information holding means 61, and the key generation means 18 generates a key for encrypting the device key 11 using the read device inherent information 16 and the device inherent value 17, in the same manner as described for the first embodiment. Next, the control means 65 reads the device key 11 from the device information holding means 61, and the device key encryption means 12 encrypts the read device key 11 using the key generated in the key generation means 18 under the control of the control means 65, thereby generating an encrypted device key. Then, the encrypted device key generated in the device key encryption means 12 is recorded in the encrypted device information recording means 66 by the control means 65.

As described above, the device key encryption apparatus 63 according to the third embodiment is provided with the control means 65 for controlling the device key encryption apparatus 63. Under the control of the control means 65, the key generation means 18 generates a key for encrypting the device key 11, using the device inherent value 17 as a concealed constant value and the device inherent information 16 that varies from device to device, and the device key encryption means 12 encrypts the device key 11 using the key generated in the key generation means 18 to obtain an encrypted device key. Therefore, in addition to the effects of the first embodiment, the construction of the device key encryption apparatus 63 can be simplified, whereby the whole device can be constructed at low cost.

Further, since at least the device inherent value 17, the key generation means 18, and the device key encryption means 12 are integrated on the single LSI 65, it becomes difficult for the third party to decrypt the device inherent value 17, the key generation means 18, and the device key encryption means 12. Thereby, it is possible to conceal what key and what algorithm have been used for encrypting the device key 11, resulting in improved security of the system. Further, according to the third embodiment, it is possible to provide the device key encryption apparatus 63 that can safely encrypt the device key 11 while concealing it from the third party, and that cannot be practically decrypted by an illegal attack from the outside.

While in this third embodiment the control means 65 controls the device key encryption apparatus 63, the control means 65 may control another LSI (not shown) as well as the device key encryption apparatus 63. In this case, the construction of the other LSI can also be simplified, and thereby the whole device can be constituted at lower cost.

Further, while in this third embodiment at least the encrypted device key 71 is recorded in the encrypted device information recording means 66, other information, such as an encrypted device key to be utilized in another LSI (not shown), may be recorded in the encrypted device information recording means 66. Further, while in the above description the device inherent information 16 is held in the device information holding means 61, the device inherent information 16 may be recorded in the encrypted device information recording means 66. The device inherent information 16 may be encrypted when being recorded. In this case, the key generation means 18 generates a key using the device inherent value and either the device inherent information obtained by decrypting the encrypted device inherent information or the encrypted device inherent information as it is. In this case, the device inherent information 16 can also be concealed from the third party, whereby the security of the system is further improved.

Furthermore, the device information hold means 61 and the encrypted device information recording means 66 may be constituted by the same memory. In this case, however, since the device key 11 and the encrypted device key undesirably exist in the single memory, the device key 11 should be automatically erased by, for example, erasing the device key 11 or writing the encrypted device key over the device key 11 when the encrypted device key is recorded in the encrypted device information recording means 66. Thereby, the plural memories required in the device can be commonized, whereby the device can be constituted at low cost, and the security of the system can be improved.

Further, the device key encryption apparatus according to the third embodiment may be implemented by software with the same effects as described above.

[Embodiment 4]

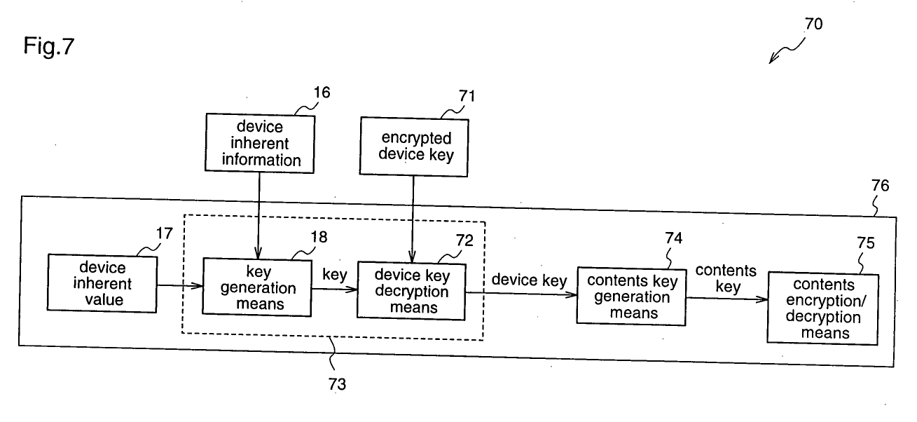

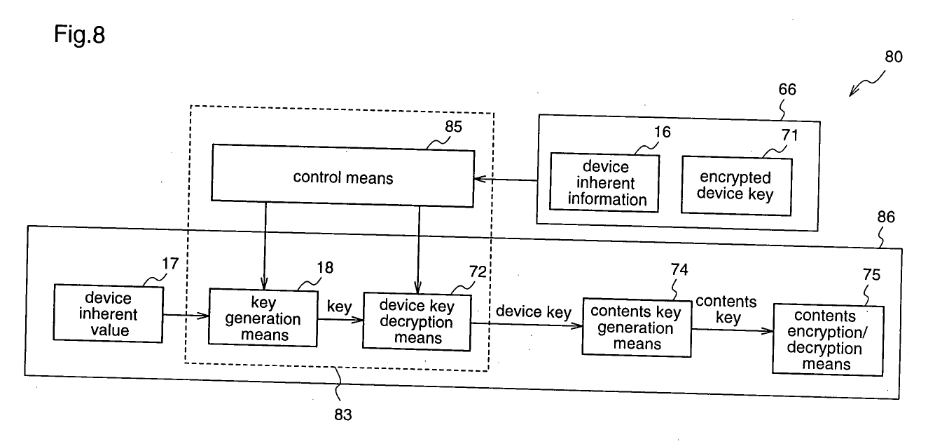

Hereinafter, a device key decryption apparatus according to a fourth embodiment will be described with reference to FIGS. 7 and 8. The device key decryption apparatus according to the fourth embodiment is paired with the device key encryption apparatus 13 or 53 according to the first or third embodiment, and decodes the encrypted device key obtained in the device key encryption apparatus 13 or 53 to obtain the device key 11. When the device key decryption apparatus according to the fourth embodiment is paired with the above-mentioned device key encryption apparatus, the device key decryption apparatus has the same device inherent information and device inherent value as those of the device key encryption apparatus.

FIG. 7 is a block diagram illustrating the construction of a contents encryption/decryption apparatus including the device key encryption apparatus according to the fourth embodiment. In FIG. 7, reference numeral 70 denotes a contents encryption/decryption apparatus for encrypting or decrypting contents, numeral 71 denotes an encrypted device key, numeral 73 denotes a device key decryption apparatus for decrypting the encrypted device key, numeral 74 denotes a contents key generation means for generating a contents key using the device key 11 obtained in the device key decryption apparatus 73, and numeral 75 denotes a contents encryption/decryption means for encrypting or decrypting contents (not shown) inputted from the outside. The device key decryption apparatus 73 comprises the key generation means 18 and the device key decryption means 72. The key generation means 18 included in the device key decryption apparatus 73 generates a key for decrypting the device key 11 using the device inherent value 17 and the device inherent information 16 which are concealed from the third party as described for the first embodiment, and the device key decryption means 72 decrypts the encrypted device key 71 using the key generated in the key generation means 18. Further, reference numeral 76 denotes a single LSI, and at least the device inherent value 17, the key generation means 18, and the device key decryption means 72 are integrated on the LSI 76, and desirably, the contents key generation means 74 and the contents encryption/decryption means 75 are also integrated on the single LSI 76. In this fourth embodiment, the device inherent value 17, the device key decryption apparatus 73, the contents key generation means 74, and the contents encryption/decryption means 75 are integrated on the single LSI 76.

Next, the operation of the device key decryption apparatus 74 constructed as described above will be described.

In the device key decryption apparatus 73, as described above, a key for decrypting the encrypted device key 71 is generated by the key generation means 18 using the device inherent information 16 and the device inherent value 17, in the same manner as described for the first embodiment. Then, the encrypted device key 71 is decrypted by the device key decryption means 72 using the key generated by the key generation device 18, thereby obtaining the device key 11.

In this fourth embodiment, as shown in FIG. 8, the device key decryption apparatus 83 may be further provided with a control means 85 for controlling the device key decryption apparatus 83, and an encrypted device information recording means 66 for holding the device inherent information 16 and the encrypted device key 71. FIG. 8 is a block diagram illustrating the construction of a contents encryption/description apparatus including a device key decryption apparatus having another construction according to the fourth embodiment.

The operation of the device key decryption apparatus 83 constructed as described above is as follows. Initially, the control means 85 reads the device inherent information 16 from the encrypted device information recording means 66, and the key generation means 18 generates a key for decrypting the encrypted device key 71 using the device inherent information 16 and the device inherent value 17 under the control of the control means 85. Next, the control means 85 reads the encrypted device key 71 from the encrypted device information recording means 66, and the device key decryption means 72 decrypts the encrypted device key 71 using the key generated by the key generation means 18 under the control of the control means 85, thereby obtaining the device key 11. In this way, when the device key decryption apparatus 83 is provided with the control means 85, the construction of the device key decryption apparatus 83 can be simplified, whereby the whole device can be constructed at low cost.

Then, a contents key is generated by the contents key generation means 74 using the device key 11 that is decrypted by the device key decryption apparatus 73 or 83, and encryption of decryption of contents (not shown) supplied from the outside is carried out by the contents encryption/decryption means 75 using the contents key.

As described above, according to the fourth embodiment, the device key decryption apparatus 73 is provided with the key generation means 18 for generating a key for decrypting the encrypted device key 71 using the device inherent value 17 and the device inherent information 16 that varies from device to device, and the device key decryption means 72 decrypts the encrypted device key 71 using the key generated by the key generation means 18 to obtain the device key 11. Therefore, the key for decrypting the encrypted device key 71 can be varied from device to device, thereby making it impossible for the third party to easily estimate the device key 11 from the encrypted device key 71, resulting in improved security of the system.

Further, when at least the device inherent value 17, the key generation means 18, and the device key decryption means 72 are integrated on the same LSI 76, it becomes difficult for the third party to decrypt the device inherent value 17, the key generation means 18, and the device key decryption means 72. Thereby, it is possible to provide the device key decryption apparatus 73 which can conceal, from the third party, what key and what algorithm have been used for decrypting the encrypted device key 71, and cannot be practically decrypted even by an illegal attack from the outside. When, desirably, the contents key generation means 74 and the contents encryption/decryption means 75 are also integrated on the same LSI 176, not only the decryption method for the encrypted device key 71 but also the contents key generation method as well as the contents encryption and decryption methods can be concealed from the third party, resulting in further improvement in the security of the system.

Further, when the device key decryption apparatus 83 is provided with the control means 85 as shown in FIG. 8, the circuit construction on the LSI 86 can be simplified. Further, when the device inherent information 16 and the encrypted device key 71 are retained in the same memory, the device can be constituted at lower cost. The control means 85 is not necessarily included in the device key decryption apparatus 83. The control means 85 may be provided outside the device key decryption apparatus 83, or it may control another function on the LSI 86 in addition to the device key decryption apparatus 83. Further, the control means 85 may also control another LSI (not shown). In this case, the construction of the LSI 86 or the other LSI can be simplified, and thereby the whole device can be obtained at lower cost.

When the device inherent information 16 is recorded in the encrypted device information recording means 66, it may be encrypted as described for the third embodiment. In this case, the key generation means 18 generates a key using the device inherent value 17, and either the device inherent information 16 obtained after decrypting the encrypted device inherent information or the encrypted device inherent information as it is, whereby the device inherent information 16 can also be concealed, resulting in further improvement in the security of the system.

Furthermore, the device key decryption apparatus according to the fourth embodiment may be implemented by software with the same effects as described above.

[Embodiment 5]

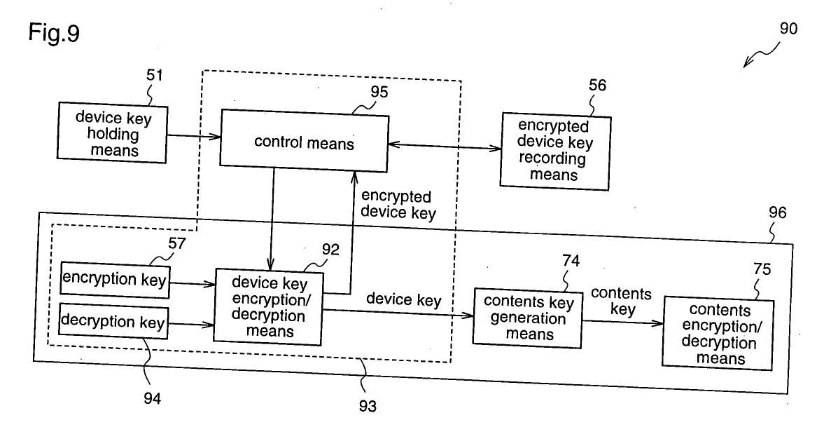

Hereinafter, a device key encryption/decryption apparatus according to a fifth embodiment of the present invention will be described with reference to FIG. 9. The device key encryption/decryption apparatus according to the fifth embodiment obtains an encrypted device key 71 by encrypting the device key 11 or obtains the device key 11 by decrypting the encrypted device key 71, using an encryption key or a decryption key which has previously been contained in the device key encryption/decryption apparatus, respectively.

FIG. 9 is a block diagram illustrating the construction of a contents encryption/decryption apparatus including the device key encryption/decryption apparatus according to the fifth embodiment. In FIG. 9, reference numeral 90 denotes a contents encryption/decryption apparatus for encrypting or decrypting contents, numeral 51 denotes a device key holding means for holding the device key 11, numeral 93 denotes a device key encryption/decryption apparatus, numeral 74 denotes a contents key generation means for generating a contents key using the device key 11 obtained in the device key encryption/decryption apparatus 93, and numeral 75 denotes a contents encryption/decryption means for encrypting or decrypting contents (not shown) which are supplied from the outside, using the contents key generated in the contents key generation means 74. The device key encryption/decryption apparatus 93 includes an encryption key 57 for encrypting the device key, a decryption key 94 for decrypting an encrypted device key 71, a device key decryption means 92, and a control means 95 for controlling the device key decryption apparatus 93. Preferably, the control means 95 is a microcomputer, and the device key holding means 51 and the encrypted device key recording means 56 are EEPROMs. As an example of a key system for the encryption key 57 and the decryption key 94 which are different keys, a public-key encryption system is well known.

Further, reference numeral 96 denotes a single LSI, and at least the encryption key 57, the decryption key 94, and the device key encryption/decryption means 92 are integrated on the LSI 96, and desirably, the contents key generation means 74 and the contents encryption/decryption means 75 are also integrated on the single LSI 96. In this fifth embodiment, the encryption key 57, the decryption key 94, the device key encryption/decryption means 92, the contents key generation means 74, and the contents encryption/decryption means 75 are integrated on the single LSI 96.

In this way, the device key encryption/decryption apparatus 93 is not constituted by software or the like on a microcomputer, and further, the encryption key 57 for encrypting the device key 11, the decryption key 94 for decrypting the encrypted device key 71, and the device key encryption/decryption means 92 for encrypting or decrypting the device key 11 using the encryption key 57 and the decryption key 94 are integrated on the LSI 96, whereby it becomes difficult for the third party to decrypt the encryption key 57, the decryption key 94, and the device key encryption/decryption means 92. Further, it is possible to conceal, from the third party, what key and what algorithm have been used for encrypting the device key 11 or what key and what algorithm have been used for decrypting the encrypted device key 71.

Hereinafter, the operation of the device key encryption/decryption apparatus 93 constituted as described above will be described.

In the device key encryption/decryption apparatus 93 according to the fifth embodiment, when encrypting the device key 11, initially the control means 95 reads the device key 11 held in the device key holding means 51, and controls the device key encryption/decryption means 92 to encrypt the device key 11 that is read by the encryption key 57, thereby obtaining the encrypted device key 71. Then, the encrypted device key 71 thus obtained is written in the encrypted device key recording means 56 by the control means 95. The above-described encrypting operation is carried out not when the device is actually operated but when the device is manufactured by only onetime, and the device key holding means 51 is connected to the control means 95 only at this time. That is, when the device is actually operated, the device key 11 is not present in the device, and only the encrypted device key 71 is stored in the encrypted device key recording means 56.

When decrypting the encrypted device key 71, that is, when using the device key for the actual operation, initially the control means 95 controls the device key encryption/decryption means 92 to change the operation mode to decryption. Then, the control means 95 reads the encrypted device key 71 from the encrypted device key recording means 56, and controls the device key encryption/decryption means 92 to decrypt the encrypted device key 71 that is read by the decryption key 94, thereby obtaining the device key 11.

Thereafter, the contents key generation means 74 generates a contents key by the decrypted device key 11, and the contents encryption/decryption means 75 performs encryption or decryption of the contents (not shown) supplied from the outside, using the contents key.

As described above, according to the fifth embodiment of the invention, since the encryption key 57, the decryption key 94, and the device key encryption/decryption means 92 are integrated on the same LSI 96, even when the device key 11 is encrypted or the encrypted device key 71 is decrypted using the encryption key 57 or the decryption key 94 which have previously been contained in the device encryption/decryption apparatus 93, it becomes difficult for the third party to decrypt the encryption key 57, the decryption key 94, and the device key encryption/decryption means 92. Thereby, it is possible to conceal, from the third party, what key and what algorithm have been used for encrypting the device key 11 or what key and what algorithm have been used for decrypting the encrypted device key 71, resulting in improved security of the system. Furthermore, according to the fifth embodiment, it is possible to provide the device key encryption/decryption apparatus 93 which can safely encrypt or decrypt the device key 11 or the encrypted device key 71 while concealing the same from the third party, and cannot be practically decrypted even by an illegal attack from the outside. Furthermore, the above-mentioned encrypting operation by the device key encryption/decryption apparatus 93 is carried out, not when the device is actually operated, but only onetime when the device is manufactured, and therefore, the device key holding means 51 is connected to the control means 95 only when the device is manufactured. Thereby, the device key 11 and the encrypted device key 71 are prevented from simultaneously existing in the device, resulting in further improvement in the security of the system.

Further, according to the fifth embodiment, since the encryption key 57, the decryption key 94, and the device key encryption/decryption means 92 are provided on the LSI 96 so that encryption and decryption of the device key can be carried out on the signal LSI 96, the construction of the device can be simplified, whereby the whole device can be constituted at low cost.

Further, while in this fifth embodiment the control means 95 controls the device key encryption/decryption apparatus 93, the control means 95 may control another means on the LSI 96 as well as the device key encryption/decryption apparatus 93, or the control means 95 may control another LSI circuit (not shown). Further, when the device key encryption/decryption apparatus 93 does not include the control means 95, it may be controlled by a control means for controlling another LSI. In this case, not only the construction of the LSI 96 but also the construction of the other LSI can be simplified, whereby the whole device can be constructed at low cost.

Further, as described for the third embodiment, a device key of another LSI (not shown) or other information may be recorded in the encrypted device key recording means 56. In this case, the device can be constructed at lower cost.

Furthermore, the device key holding means 51 and the encrypted device key recording means 56 may be constructed by the same memory. In this case, however, since the device key 11 and the encrypted device key undesirably exist in the single memory, the device key 11 recorded in the encrypted device key recording means 56 should be automatically erased by, for example, erasing the device key 11 or writing the encrypted device key 71 over the device key 11 when the encrypted device key 71 is written in the encrypted device information recording means 56. Thereby, the plural memories required in the device can be commonized, and the device can be constituted at lower cost. Further, it is possible to prevent the device key 11 and the encrypted device key 71 from simultaneously existing in the same memory, resulting in further improvement in the security of the system.

While the device key encryption/decryption apparatus 93 according to the fifth embodiment uses different keys for encryption and decryption, respectively, it may use a single secret key as the encryption key 57 and the decryption key 94. As examples of such private-key encryption system, DES and AES (Advanced Encryption Standard) are well known.

[Embodiment 6]

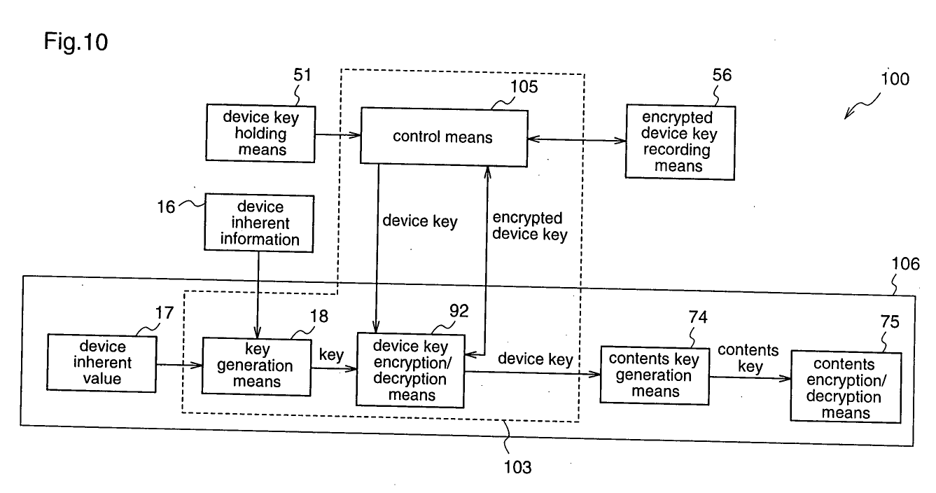

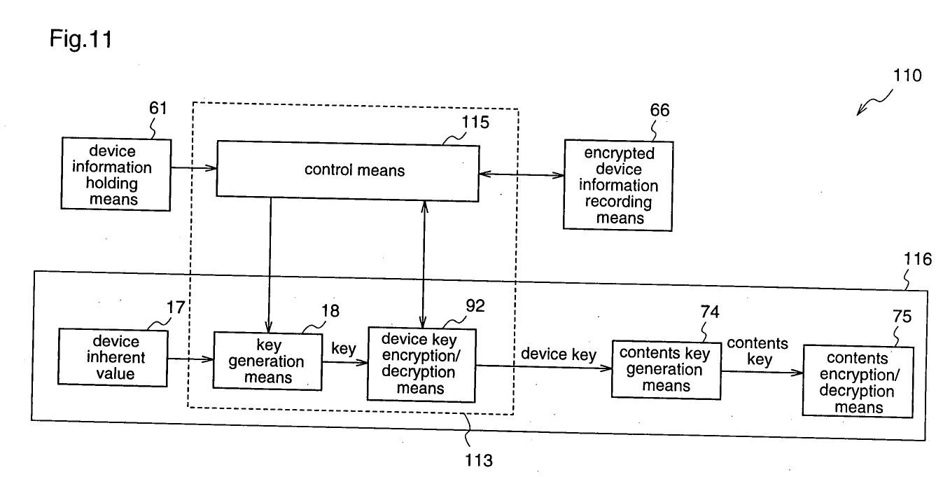

Hereinafter, a device key encryption/decryption apparatus according to the sixth embodiment will be described with reference to FIGS. 10 and 11. While the device key encryption/decryption apparatus according to the fifth embodiment encrypts or decrypts the device key using the encryption key or the decryption key contained in the device key encryption/decryption apparatus so as not to be decrypted by the third party, the device key encryption/decryption apparatus according to the sixth embodiment generates a key for encrypting or decrypting the device key 11 using such as inherent information that varies from device to device, and encrypts or decrypts the device key using the generated key.

FIG. 10 is a diagram illustrating the construction of a contents encryption/decryption apparatus including the device key encryption/decryption apparatus of the sixth embodiment. In FIG. 10, reference numeral 100 denotes a contents encryption/decryption apparatus for encrypting or decrypting the contents, numeral 51 denotes a device key holding means for holding the device key 11, numeral 103 denotes a device key encryption/decryption apparatus, numeral 74 denotes a contents key generation means for generating a contents key using the device key 11 obtained by the device key encryption/decryption apparatus 103, and numeral 75 denotes a contents encryption/decryption means for encrypting or decrypting contents (not shown) supplied from the outside, using the contents key generated in the contents key generation means 74. The device key encryption/decryption apparatus 103 is provided with a key generation means 18 for generating a key for encrypting or decrypting the device key using the device inherent value 17 and the device inherent information 16 that are concealed from the third party as described for the first embodiment, and a control means 105 for controlling the device key encryption/decryption means 92 and the device key encryption/decryption apparatus 103. Preferably, the control means 105 is a microcomputer, and the device key holding means 51 and the encrypted device key recording means 56 are EEPROMs. Further, reference numeral 106 denotes a single LSI. At least the device inherent value 17, the key generation means 18, and the device key encryption/decryption means 92 are integrated on the LSI 106, and desirably, the contents key generation means 74 and the contents encryption/decryption means 75 are also integrated on the single LSI 106. In this sixth embodiment, the device inherent value 17, the key generation means 18, the device key encryption/decryption means 92, the contents key generation means 74, and the contents encryption/decryption means 75 are integrated on the single LSI 106.

The operation of the device key encryption/decryption apparatus 103 constructed as described above will be described.

In the device key encryption/decryption apparatus 103 according to the sixth embodiment, when encoding the device key 11, initially the key generation means 18 generates a key for encrypting the device key 11 using the device inherent information 16 and the device inherent value 17 in the same manner as described for the first embodiment. Next, the control means 105 reads the device key 11 from the device key holding means 51. Then, under the control of the control means 105, the device key encryption/decryption means 92 encrypts the read device key 11 using the key generated by the key generation means, thereby generating the encrypted device key 71. Then, the encrypted device key 71 generated by the device key encryption/decryption is written in the encrypted device key recording means 56 by the control means 105. As described for the fifth embodiment, the above-mentioned encrypting operation is carried out, not when the device is actually operation, but only onetime when the device is manufactured, and the device key holding means 51 is connected to the control means 105 only at this time. That is, during actual operation of the device, the device key 11 is not present in the device, and only the encrypted device key 71 is present in the device, i.e., stored in the encrypted device key recording means 56.

When decrypting the encrypted device key 71 that is recorded in the encrypted device key recording means 56, i.e., when the device is used in the actual operation, initially the control means 105 controls the device key encryption/decryption means 92 to change the operation mode to decryption. Then, the key generation means 18 generates a key for decrypting the encrypted device key 71, using the device inherent information 16 and the device inherent value 17, under the control of the control means 105. Next, the control means 105 reads the encrypted device key 71 from the encrypted device key recording means 56. Then, under the control of the control means 105, the device key encryption/decryption means 92 decrypts the encrypted device key 71 using the key generated by the key generation means 18, thereby obtaining the device key 11.

A device information holding means 61 for holding the device key 11 and the device inherent information 16 may be provided as shown in FIG. 11, instead of the device key holding means 51 of the contents encryption/decryption apparatus 100 according to the sixth embodiment. FIG. 11 is a block diagram illustrating the construction of a contents encryption/decryption apparatus including the device key decryption apparatus having another construction according to the sixth embodiment.

In the device key encryption/decryption apparatus 110 shown in FIG. 11, when encrypting the device key 11, initially the control means 115 reads the device inherent information 16 from the device information recording means 61, and the key generation means 18 generates a key for encrypting the device key 11 using the read device inherent information 16 and device inherent value 17, under the control of the control means 115. Next, the control means 115 reads the device key 11 from the device information recording means 61, and the device key encryption/decryption means 92 encrypts the device key 11 using the key generated by the key generation means 18, under the control of the control means 115, thereby to obtain the encrypted device key 71. Also in this case, the above-mentioned encryption operation is carried out not when the device is actually operated but only onetime when the device is manufactured, and the device information holding means 61 is connected to the control means 115 only at this time. Therefore, during actual operation of the device, the device key 11 is not present in the device, and only the encrypted device key 71 is stored in the encrypted device information recording means 66. When decrypting the encrypted device key 71, the control means 115 reads the device inherent information 16 from the device information recording means 61, and the key generation means 18 generates a key for decrypting the encrypted device key 71 using the read device inherent information 16 and device inherent value 17, under the control of the control means 115.

Thereafter, the contents key generation means 74 generates a contents key using the device key 11 that is decrypted by the device key encryption/decryption apparatus 103 or 113, and the contents encryption/decryption means 75 performs encryption or decryption of contents (not shown) supplied from the outside, using the contents key.

As described above, according to the sixth embodiment, the device key encryption/decryption apparatus 103 is provided with the key generation means 18 for generating a key for encrypting or decrypting the device key 11, using the device inherent value 17 and the device inherent information 16 that varies from device to device, and the device key encryption/decryption means 92 encrypts the device key 11 or decrypts the encrypted device key 71 using the key generated by the key generation means 18, thereby obtaining the encrypted device key 71 or the device key 11. Therefore, the key for encrypting the device key 11 or decrypting the encrypted device key 71 can be varied from device to device, thereby making it impossible for the third party to easily estimate the device key 11 from the encrypted device key 71. As a result, the security of the system can be improved. Since the device key encryption/decryption apparatus 103 is constructed as described above, the contents encryption/decryption apparatus 100 can encrypt and decrypt the contents with safety while concealing the device key 11 from the third party. Further, the device inherent information 16 may be encrypted. In this case, the key generation means 18 generates a key using the device inherent value 17, and either the device inherent information that is obtained after decrypting the encrypted device inherent information 16 or the encrypted device inherent information as it is. Thereby, the device inherent information can also be concealed, resulting in further improvement in the security of the device.

Further, according to the sixth embodiment, since the key generation means 18 and the device key encryption/decryption means 92 are provided on the LSI 106 or 116 so that both of encryption and decryption of the device key can be carried out on the single LSI 106 or 116, the construction of the device can be simplified, whereby the whole device can be constituted at low cost.

Further, in this sixth embodiment, since at least the device inherent value 17, the key generation means 18, and the device key encryption/decryption means 92 are integrated on the same LSI 106 or 116, it becomes difficult for the third party to decrypt the device inherent value 17, the key generation means 18, and the device key encryption/decryption means 92. Thereby, it is possible to conceal, from the third party, what key and what algorithm have been used for encrypting the device key 11 or what key and what algorithm have been used for decrypting the encrypted device key 71, resulting in improved security of the system. Furthermore, according to the sixth embodiment, it is possible to provide the device key encryption/decryption apparatus 103 or 113 which can safely encrypt or decrypt the device key 11 or the encrypted-device key 71 while concealing the same from the third party, and cannot be practically decrypted even by an illegal attack from the outside. When, desirably, the contents key generation means 74 and the contents encryption/decryption means 75 are also integrated on the same LSI 106, not only the encryption method for the device key 11 or the decryption method for the encrypted device key 71 but also the contents key generation method as well as the contents encryption and decryption methods can be concealed from the third party, resulting in further improvement in the security of the system.

Further, while in this sixth embodiment the control means 105 controls the device key encryption/decryption apparatus 103, the control means 105 may control another means on the LSI 106 as well as the device key encryption/decryption apparatus 103, or the control means 105 may control another LSI circuit (not shown). Further, when the device key encryption/decryption apparatus 103 does not include the control means 105, it may be controlled by a control means for controlling another LSI. In this case, not only the construction of the LSI 106 but also the construction of the other LSI can be simplified, whereby the whole device can be constructed at low cost.

Further, as described for the third embodiment, other information such as a device key of another LSI (not shown) may be recorded in the encrypted device key recording means 56 shown in FIG. 10 or the encrypted device information recording means 66 shown in FIG. 11. Further, information to be utilized in another LSI may be stored in the device information holding means 61 shown in FIG. 11. When the device inherent information 16 is recorded in the encrypted device information recording means 66, the memory can be commonized, resulting in further reduction in the cost of the whole device.

Further, in the above description, the device key holding means 51 and the encrypted device key recording means 56 are separated memories, the device key holding means 51 and the encrypted device key recording means 56 may be constituted by the same memory. In this case, however, since the device key 11 and the encrypted device key undesirably exist in the single memory, the device key 11 recorded in the encrypted device key recording means 56 should be automatically erased by, for example, erasing the device key 11 or writing the encrypted device key 71 over the device key 11 when the encrypted device key 71 is written in the encrypted device information recording means 56. In this case, the plural memories required in the device can be commonized, whereby the device can be constituted at lower cost, and furthermore, the security of the system can be improved. Further, also in the construction shown in FIG. 11, the device information holding means 61 and the encrypted device information recording means 66 can be constituted by the same memory. Also in this case, the same effects as described above can be achieved by setting the apparatus so that the device key 11 recorded in the encrypted device key recording means 56 can be automatically erased.

Further, the device key encryption/decryption apparatus according to the sixth embodiment may be implemented by software with the same effects as described above.

[Embodiment 7]

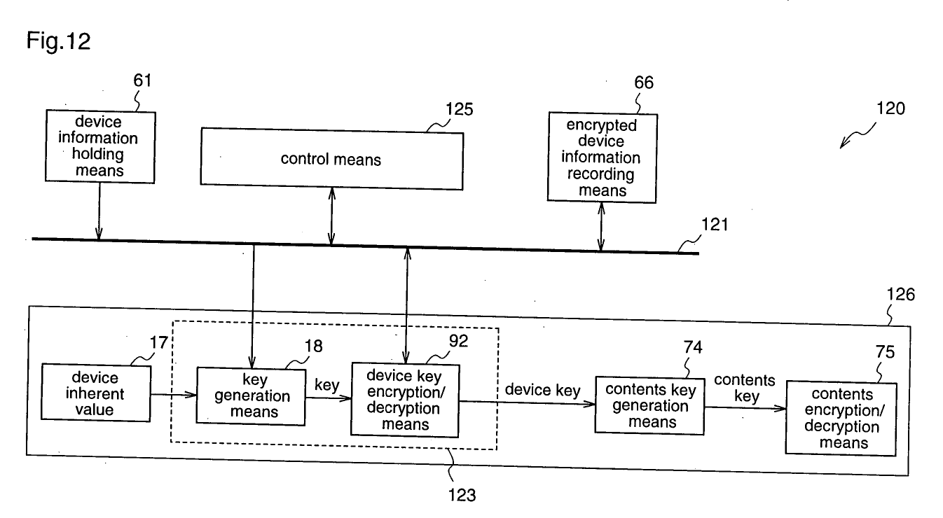

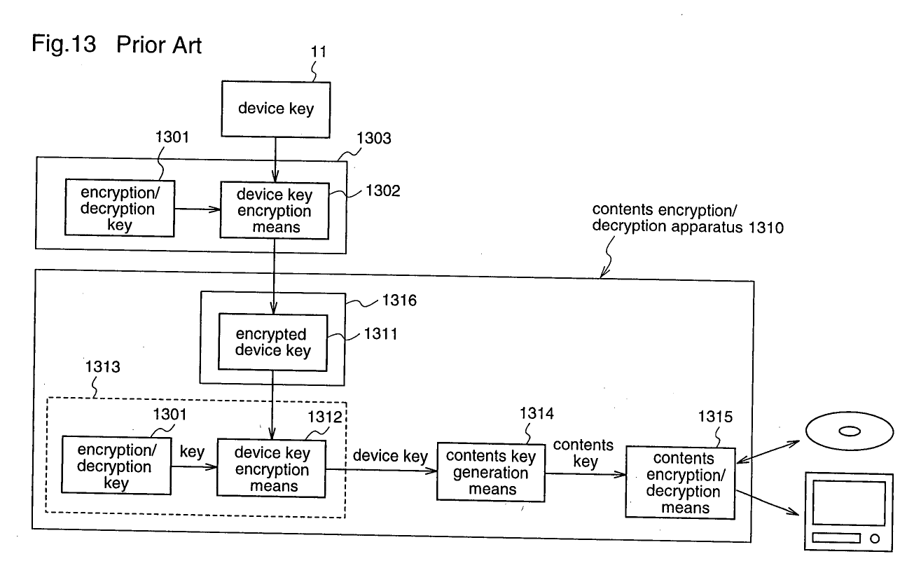

Hereinafter, a device key encryption/decryption apparatus according to a seventh embodiment will be described with reference to FIG. 12. In the device key encryption/decryption apparatus according to the seventh embodiment, the respective constituents are connected by a bus.

FIG. 12 is a diagram illustrating the construction of a contents encryption/decryption apparatus including the device key encryption/decryption apparatus according to the seventh embodiment. In FIG. 12, reference numeral 120 denotes for encrypting or decrypting contents, numeral 61 denotes a device information holding means for holding the device key 11 and the device inherent information 16, numeral 123 denotes a device key encryption/decryption apparatus, numeral 125 denotes a control means for controlling the device key encryption/decryption apparatus 123, numeral 66 denotes an encrypted device information recording means for recording at least the encrypted device key 71 that is obtained by the device key encryption/decryption apparatus 123, numeral 74 denotes a contents key generation means for generating a contents key using the device key 11 obtained by the device key encryption/decryption apparatus 123, and numeral 75 denotes a contents encryption/decryption means for encrypting or decrypting contents (not shown) supplied from the outside, using the contents key generated by the contents key generation means 74. As described for the first embodiment, the device key encryption/decryption apparatus 123 is provided with a key generation means 18 for generating a key for encrypting or decrypting the device key using the device inherent value 17 and the device inherent information 16, and a device key encryption/decryption means 92 for encrypting or decrypting the device key using the key generated by the key generation means 18. Preferably, the control means 125 is a microcomputer, and the device information holding means 61 and the encrypted device information recording means 66 are EEPROMs. Further, reference numeral 126 denotes a single LSI, and at least the device inherent value 17, the key generation means 18, and the device key encryption/decryption means 92 are integrated on the LSI 126. Preferably, the contents key generation means 74 and the contents encryption/decryption means 75 are also integrated on the single LSI 126. In this seventh embodiment, the device inherent value 17, the key generation means 18, the device key encryption/decryption means 92, the contents key generation means 74, and the contents encryption/decryption means 75 are integrated on the single LSI 126. Further, in this seventh embodiment, the device information holding means 61, the control means 125, the encrypted device information recording means 66, and the LSI 126 are arrange on a common bus 121. As examples of the bus 121, there have been known an 12C bus to be used as an external bus or an internal bus for a microcomputer, a PCI bus to be used for a personal computer, and the like.

The operation of the device key encryption/decryption apparatus 123 constructed as described above is identical to that of the device key encryption/decryption apparatus 113 shown in FIG. 6 according to the sixth embodiment, and therefore, repeated description is not necessary.

As described above, according to the seventh embodiment, the device key encryption/decryption apparatus is provided with the key generation means 18 for generating a key for encrypting or decrypting the device key 11, using the device inherent value 17 and the device inherent information 16 that varies from device to device, and the device key encryption/decryption means 92 encrypts the device key 11 or decrypts the encrypted device key 71 using the key generated by the key generation means 18, thereby to obtain the encrypted device key 71 or the device key 11. Further, the key generation means 18 and the device key encryption/decryption means 92 are provided on the same LSI 126 so that both of encryption and decryption for the device key can be carried out on the single LSI 126, and further, the memories in the device are commonized. Therefore, it is possible to constitute a device that makes it impossible for the third party to easily estimate the device key 11 from the encrypted device key 71, and that improves the security of the system, at low cost.

Further, in this seventh embodiment, at least the device inherent value 17, the key generation means 18, and the device key encryption/decryption means 92 (desirably, also the content key generation means 74 and the contents encryption/decryption means 75) are integrated on the same LSI 126, it is possible to conceal, from the third party, what key and what algorithm have been used for encrypting the device key 11 or what key and what algorithm have been used for decrypting the encrypted device key 71, whereby the security of the system can be improved. Furthermore, according to the seventh embodiment, it is possible to provide the device key encryption/decryption apparatus 123 which can safely encrypt or decrypt the device key 11 or the encrypted device key 71 while concealing the same from the third party, and cannot be practically decrypted even by an illegal attack from the outside. Furthermore, the contents key generation method as well as the contents encryption and decryption methods can also be concealed from the third party, resulting in further improvement in the security of the device. Further, other information such as a device key of another LSI (not shown) may be recorded in the encrypted device key recording means 66 or, likewise, information to be utilized in another LSI may be recorded in the device information holding means 61. Furthermore, while in the above description the device inherent information 16 is stored in the device information holding means 61, it may be stored in the encrypted device information recording means 66. In this case, the memories in the device can be commonized, whereby the whole device can be constituted at low cost. As described above, the device inherent information 16 may be encrypted when it is stored in the encrypted device information recording means 66. In this case, the key generation means 18 generates a key using the device inherent value 17, and either the device inherent information that is obtained after decrypting the encrypted device inherent information 16 or the encrypted device inherent information as it is, whereby also the device inherent information 16 can be concealed, resulting in further improvement in the security of the device.

Furthermore, the device key holding means 61 and the encrypted device key recording means 66 may be constituted by the same memory. In this case, however, since the device key 11 and the encrypted device key undesirably exist in the single memory, the device key 11 recorded in the memory should be automatically erased by, for example, erasing the device key 11 or writing the encrypted device key 71 over the device key 11 when the encrypted device key 71 is written in memory. In this case, the plural memories required in the device can be commonized, whereby the device can be constituted at lower cost. Further, since the device key 11 and the encrypted device key 71 are prevented from simultaneously existing in the same memory, the security of the system can be further improved.

Further, the device key encryption/decryption apparatus according to the seventh embodiment may be implemented by software with the same effects as described above.

Further, it is needless to say that the construction using the bus 121 as shown in FIG. 12 is applicable to the above-described first to sixth embodiments.

What is claimed is:

1. A device key decryption apparatus for decrypting an encrypted device key which is obtained by encrypting a device key that is the basis of a contents key for encrypting or decrypting contents and varies from device to device, said apparatus including:
a key generation means for generating a key, using device inherent information that is given to a device, and a device inherent value that is a predetermined constant value; and
a device key decryption means for decrypting the encrypted device key using the key generated by the key generation means, thereby to output the device key.

2. A device key decryption apparatus as defined in claim 1, wherein the device inherent information and the encrypted device key are stored in the same memory.

3. A device key decryption apparatus as defined in claim 1, wherein the device inherent value, the key generation means, and the device key decryption means are integrated on the same LSI.

4. A device key decryption apparatus for decrypting an encrypted device key which is obtained by encrypting a device key that is the basis of a contents key for encrypting or decrypting contents and varies from device to device, said apparatus including:
an encrypted device information holding means for holding device inherent information that is given to a device, and the encrypted device key;
a key generation means for generating a key using a device inherent value that is a predetermined constant value, and the device inherent information;
a device key decryption means for decrypting the encrypted device key using the key generated by the key generation means, thereby to output the device key; and
a control means for controlling the encrypted device information holding means, the key generation means, and the device key decryption means.

5. A device key decryption apparatus as defined in claim 4, wherein the device inherent value, the key generation means, and the device key decryption means are integrated on the same LSI.

6. The device key decryption apparatus as defined in claim 4, wherein
the device inherent information is encrypted and held; and
the key generation means generates a key using the device inherent value, and either the encrypted device inherent information or the decrypted device inherent information that is obtained after decrypting the encrypted device inherent information.

7. A device key decryption apparatus as defined in claim 4, wherein the encrypted device information holding means holds information possessed by another device key decryption apparatus that is different from the device key decryption apparatus, in addition to the device inherent information and the encrypted device key.

8. A device key decryption apparatus as defined in claim 1 or 4, wherein the device inherent information comprises at least one of classification data that identify the device.

9. A device key decryption apparatus as defined in claim 8, wherein the classification data include a code of a maker that manufactures the device, a code of a factory where the device is manufactured, a product field code of the device, a product model code of the device, and a serial number of the device.

10. A device key decryption apparatus as defined in claim 1 or 4, wherein the device inherent information varies from device to device.

11. A device key decryption apparatus as defined in claim 1 or 4, wherein the key generation means is an exclusive OR circuit which calculates an exclusive OR of the device inherent information and the device inherent value, thereby to generate a key.

12. A device key decryption apparatus as defined in claim 1 or 4, wherein the key generation means is an encryption circuit which encrypts the device inherent information using the device inherent value as a key, thereby to generate a key.

13. A device key decryption apparatus as defined in claim 1 or 4, wherein the key generation means is a compression means for compressing a number sequence using a one-way function, and generates a key by compressing a number sequence that is obtained by concatenating the device inherent information with the device inherent value, using the one-way function.

14. A device key encryption apparatus for encrypting a device key which is the basis of a contents key for encrypting or decrypting contents, and varies from device to device, said apparatus including:
a key generation means for generating a key using device inherent information that is given to a device, and a device inherent value that is a predetermined constant value; and
a device key encryption means for encrypting the device key using the key generated by the key generation means, thereby to output the encrypted device key.

15. A device key encryption apparatus as defined in claim 14, wherein the device inherent information and the device key are stored in the same memory.

16. A device key encryption apparatus as defined in claim 14, wherein the device inherent value, the key generation means, and the device key encryption means are integrated on the same LSI.

17. A device key encryption apparatus for encrypting a device key that is the basis of a contents key for encrypting or decrypting contents, and varies from device to device, said apparatus including:
a device key holding means for holding the device key;
a device key encryption means for encrypting the device key using an encryption key, thereby to output an encrypted device key;
an encrypted device key recording means for recording the encrypted device key; and
a control means for controlling the device key holding means, the device key encryption means, and the encrypted device key recording means;
wherein the encryption key and the device key encryption means are integrated on the same LSI.

18. A device key encryption apparatus as defined in claim 17, wherein the device key holding means and the encrypted device key recording means are constituted by the same memory.

19. A device key encryption apparatus as defined in claim 17, wherein the encrypted device key recording means records, in addition to the encrypted device key, information possessed by another device key encryption apparatus that is different from the device key encryption apparatus.

20. A device key encryption apparatus for encrypting a device key which is the basis of a contents key for encrypting or decrypting contents, and varies from device to device, said apparatus including:
a device information holding means for holding device inherent information given to a device, and the device key;
a key generation means for generating a key using a device inherent value that is a predetermined constant value, and the device inherent information;
a device key encryption means for encrypting the device key using the key generated by the key generation means, thereby to output an encrypted device key;
an encrypted device information recording means for recording the encrypted device key; and
a control means for controlling the device information holding means, the key generation means, the device key encryption means, and the encrypted device information recording means.

21. A device key encryption apparatus as defined in claim 20, wherein the device inherent value, the key generation means, and the device key encryption means are integrated on the same LSI.

22. A device key encryption apparatus as defined in claim 20, wherein the device information holding means and the encrypted device information recording means are constituted by the same memory.

23. A device key encryption apparatus as defined in claim 20, wherein the encrypted device information recording means records, in addition to the encrypted device key, information possessed by another device key encryption apparatus that is different from the device key encryption apparatus.

24. A device key encryption apparatus as defined in claim 20, wherein the encrypted device information recording means records the device inherent information in addition to the encrypted device key.

25. A device key encryption apparatus as defined in claim 24, wherein
the device inherent information is encrypted and recorded; and
the key generation means generates a key using the device inherent value, and either the encrypted device inherent information or the decrypted device inherent information that is obtained after decrypting the encrypted device inherent information.

26. A device key encryption apparatus as defined in claim 14 or 20, wherein the device inherent information comprises at least one of classification data that identify the device.

27. A device key encryption apparatus as defined in claim 14 or 20, wherein the device inherent information varies from device to device.

28. A device key encryption apparatus as defined in claim 14 or 20, wherein the key generation means is an exclusive OR circuit which calculates an exclusive OR of the device inherent information and the device inherent value, thereby to generate a key.

29. A device key encryption apparatus as defined in claim 14 or 20, wherein the key generation means is an encryption circuit which encrypts the device inherent information using the device inherent value as a key, thereby to generate a key.

30. A device key encryption apparatus as defined in claim 14 or 20, wherein the key generation means is a compression means for compressing a number sequence using an one-way function, and generates a key by compressing a number sequence obtained by concatenating the device inherent information with the device inherent value, using the one-way function.

31. A device key encryption/decryption apparatus for encrypting a device key that is the basis of a contents key for encrypting or decrypting contents, and varies from device to device, or decrypting an encrypted device key, said apparatus including:
a device key holding means for holding the device key;
an encrypted device key recording means for recording the encrypted device key;
a device key encryption/decryption means for encrypting the device key using an encryption key to output the encrypted device key, or decrypting the encrypted device key using a decryption key to output the device key; and
a control means for controlling the device key holding means, the encrypted device key recording means, and the device key encryption/decryption means;
wherein the encryption key, the decryption key, and the device key encryption/decryption means are integrated on the same LSI.

32. A device key encryption/decryption apparatus as defined in claim 31, wherein the encrypted device key recording means records, in addition to the encrypted device key, information possessed by another device key encryption/decryption apparatus that is different from the device key encryption/decryption apparatus.

33. A device key encryption/decryption apparatus as defined in claim 31, wherein the device key holding means and the encrypted device key recording means are constituted by the same memory.

34. A device key encryption/decryption apparatus as defined in claim 31, wherein the encryption key and the decryption key are the same secrete key.

35. A device key encryption/decryption apparatus as defined in claim 31, wherein
when encrypting the device key, the control means reads the device key from the device key holding means, controls the device key encryption/decryption means to encrypt the device key using the encryption key, and records the encrypted device key in the encrypted device key recording means; and
when decrypting the encrypted device key, the control means reads the encrypted device key from the encrypted device key recording means, controls the device key encryption/decryption means to decrypt the encrypted device key using the decryption key.

36. A device key encryption/decryption apparatus as defined in claim 35, wherein, when decrypting the encrypted device key, the device key holding means does not hold the device key, or it is dismounted from the device key encryption/decryption apparatus.

37. A device key encryption/decryption apparatus for encrypting a device key that is the basis of a contents key for encrypting or decrypting contents, and varies from device to device, or decrypting an encrypted device key, said apparatus including:
a device key holding means for holding the device key;
an encrypted device key recording means for recording the encrypted device key;
a key generation means for generating a key using device inherent information given to the device, and a device inherent value that is a predetermined constant value;
a device key encryption/decryption means for encrypting the device key using the key generated by the key generation means to output the encrypted device key, or decrypting the encrypted device key using the key generated by the key generation means to output the device key; and
a control means for controlling the device key holding means, the encrypted device key recording means, the key generation means, and the device key encryption/decryption means.

38. A device key encryption/decryption apparatus as defined in claim 37, wherein
the device inherent value, the key generation means, and the device key encryption/decryption means are integrated on the same LSI.

39. A device key encryption/decryption apparatus as defined in claim 37, wherein the encrypted device key recording means records, in addition to the encrypted device key, information possessed by another device key encryption/decryption apparatus that is different from the device key encryption/decryption apparatus.

40. A device key encryption/decryption apparatus as defined in claim 37, wherein the device key holding means and the encrypted device key recording means are constituted by the same memory.

41. A device key encryption/decryption apparatus as defined in claim 37, wherein
when encrypting the device key, the control means reads the device key from the device key holding means, controls the key generation means to generate a key for encrypting the device key, controls the device key encryption/decryption means to encrypt the device key using the key generated by the key generation means, and records the encrypted device key in the encrypted device key recording means; and
when decrypting the encrypted device key, the control means reads the encrypted device key from the encrypted device key recording means, controls the key generation means to generate a key for decrypting the encrypted device key, and controls the device key encryption/decryption means to decrypt the encrypted device key using the key generated by the key generation means.

42. A device key encryption/decryption apparatus as defined in claim 41, wherein, when decrypting the encrypted device key, the device key holding means does not hold the device key, or it is dismounted from the device key encryption/decryption apparatus.

43. A device key encryption/decryption apparatus for encrypting a device key that is the basis of a contents key for encrypting or decrypting contents, and varies from device to device, or decrypting an encrypted device key, said apparatus including:
a device information holding means for holding device inherent information given to a device, and the device key;
an encrypted device information recording means for recording the encrypted device key;
a key generation means for generating a key using device inherent that is a predetermined constant value, and the device inherent information;
a device key encryption/decryption means for encrypting the device key using the key generated by the key generation means to output the encrypted device key, or decrypting the encrypted device key using the key generated by the key generation means to output the device key; and
a control means for controlling the device information holding means, the encrypted device information recording means, the key generation means, and the device key encryption/decryption means.

44. A device key encryption/decryption apparatus as defined in claim 43, wherein the device inherent value, the key generation means, and the device key encryption/decryption means are integrated on the same LSI.

45. A device key encryption/decryption apparatus as defined in claim 43, wherein the encrypted device information recording means records, in addition to the encrypted device key, information possessed by another device key encryption/decryption apparatus that is different from the device key encryption/decryption apparatus.

46. A device key encryption/decryption apparatus as defined in claim 43, wherein the device information holding means and the encrypted device information recording means are constituted by the same memory.

47. A device key encryption/decryption apparatus as defined in claim 43, wherein the encrypted device information recording means records the device inherent information in addition to the encrypted device key.

48. A device key encryption/decryption apparatus as defined in claim 47, wherein
the device inherent information is encrypted and recorded; and
the key generation means generates a key using the device inherent value, and either the encrypted device inherent information or the decrypted device inherent information that is obtained after decrypting the encrypted device inherent information.

49. A device key encryption/decryption apparatus as defined in claim 43, wherein
when encrypting the device key, the control means reads the device key and the device inherent information from the device information holding means, controls the key generation means to generate a key for encrypting the device key, controls the device key encryption/decryption means to encrypt the device key using the key generated by the key generation means, and records the encrypted device key in the encrypted device information recording means; and
when decrypting the encrypted device key, the control means reads the encrypted device key from the encrypted device information recording means, controls the key generation means to generate a key for decrypting the encrypted device key, and controls the device key encryption/decryption means to decrypt the encrypted device key using the key generated by the key generation means.

50. A device key encryption/decryption apparatus as defined in claim 49, wherein, when decrypting the encrypted device key, the device information holding means does not hold the device key, or it is dismounted from the device key encryption/decryption apparatus.

51. A device key encryption/decryption apparatus as defined in claim 37 or 43, wherein the device inherent information comprises at least one of classification data that identify the device.

52. A device key encryption/decryption apparatus as defined in claim 37 or 43, wherein the device inherent information varies from device to device.

53. A device key encryption/decryption apparatus as defined in claim 37 or 43, wherein the key generation means is an exclusive OR circuit, and generates a key by calculating an exclusive OR between the device inherent information and the device inherent value.

54. A device key encryption/decryption apparatus as defined in claim 37 or 43, wherein the key generation means is an encryption circuit, and encrypts the device inherent information using the device inherent value as a key to generate a key.

55. A device key encryption/decryption apparatus as defined in claim 37 or 43, wherein the key generation means is a compression means for compressing a number sequence using a one-way function, and generates a key by compressing a number sequence that is obtained by concatenating the device inherent information with the device inherent value, using the one-way function.

56. A device key decryption method for decrypting an encrypted device key which is obtained by encrypting a device key that is the basis of a contents key for encrypting or decrypting contents, and varies from device to device, said method including:
generating a key for decrypting the encrypted device key using device inherent information given to the device, and a device inherent value that is a predetermined constant value, and decrypting the encrypted device key using the generated key.

57. A device key decrypting method as defined in claim 56, wherein the device inherent information varies from device to device.

58. A device key encryption method for encrypting a device key which is the basis of a contents key for encrypting or decrypting contents, and varies from device to device, said method including:
generating a key for encrypting the device key using device inherent information given to the device, and a device inherent value that is a predetermined constant value, and encrypting the device key using the generated key.

59. A device key encrypting method as defined in claim 58, wherein the device inherent information varies from device to device.

60. A device key encryption/decryption method for encrypting a device key that is the basis of a contents key for encrypting or decrypting contents, and varies from device to device, or decrypting the encrypted device key, said method including:
when encrypting the device key, generating a key for encrypting the device key using device inherent information that is given to the device, and a device inherent value that is a predetermined constant value, and encrypting the device key using the generated key to obtain an encrypted device key; and
when decrypting the encrypted device key, generating a key for decrypting the encrypted device key, and decrypting the encrypted device key using the generated key.

61. A device key encryption/decryption method as defined in claim 60, wherein the device inherent information varies from device to device.

62. A program for implementing, by a computer, a device key decryption method for decrypting an encrypted device key which is obtained by encrypting a device key that is the basis of a contents key for encrypting or decrypting contents, and varies from device to device, said program including:
generating a key for decrypting the encrypted device key using device inherent information given to the device, and a device inherent value that is a predetermined constant value, and decrypting the encrypted device key using the generated key.

63. A program for implementing, by a computer, a device key encryption method for encrypting a device key which is the basis of a contents key for encrypting or decrypting contents, and varies from device to device, said program including:
generating a key for encrypting the device key using device inherent information given to the device, and a device inherent value that is a predetermined constant value, and encrypting the device key using the generated key.

64. A program for implementing, by a computer, a device key encryption/decryption method for encrypting a device key that is the basis of a contents key for encrypting or decrypting contents, and varies from device to device, or decrypting the encrypted device key, said program including:
when encrypting the device key, generating a key for encrypting the device key using device inherent information that is given to the device, and a device inherent value that is a predetermined constant value, and encrypting the device key using the generated key to obtain an encrypted device key; and
when decrypting the encrypted device key, generating a key for decrypting the encrypted device key, and decrypting the encrypted device key using the generated key.
